(19) United States
(12) Patent Application Publication
(10) Pub. No.: US 2026/0311279 A1
(43) Pub. Date: Oct. 8, 2026

(54) PATENT CLAIM ANALYSIS APPARATUS AND METHOD OF USE THEREOF

(71) Applicants: Kevin H. Hazen, Flagstaff, AZ (US); Mark Oman, West Des Moines, IA (US)

(72) Inventors: Kevin H. Hazen, Flagstaff, AZ (US); Mark Oman, West Des Moines, IA (US)

(21) Appl. No.: 19/530,706

(22) Filed: Feb. 5, 2026

Related U.S. Application Data
(63) Continuation-in-part of application No. 19/456,199, filed on Jan. 22, 2026.
(60) Provisional application No. 63/784,040, filed on Apr. 5, 2025.
(60) Provisional application No. 63/831,456, filed on Jun. 27, 2025.
(60) Provisional application No. 63/854,762, filed on Jul. 31, 2025.
(60) Provisional application No. 63/876,986, filed on Sep. 6, 2025.
(60) Provisional application No. 63/883,253, filed on Sep. 17, 2025.
(60) Provisional application No. 63/901,546, filed on Oct. 18, 2025.
(60) Provisional application No. 63/910,161, filed on Nov. 3, 2025.
(60) Provisional application No. 63/934,562, filed on Dec. 9, 2025.

(51) Int. Cl. G06Q 50/18; G06Q 10/10

(52) U.S. Cl. CPC G06Q 50/184; G06Q 10/10

(57) ABSTRACT

The invention comprises a method for prosecuting a claim in a patent application, comprising the steps of: inputting the claim into a patent model, the patent model comprising an artificial neural network implemented on a computer system, the claim comprising at least a first element and a second element of a set of elements; assessing, with the patent model, a set of publications in a datastore for the presence of each of the first element and the second element; and reporting, as an output from the patent model, an unofficial office action comprising a claim novelty assessment for the claim, the claim novelty assessment comprising a first citation, of a first publication, of the set of publications in the datastore, citing: (1) a first snippet teaching the first element and (2) a second snippet teaching the second element.

### CROSS-REFERENCES TO RELATED APPLICATIONS

This application is a continuation-in-part of U.S. patent application Ser. No. 19/456,199 filed Jan. 22, 2026, which:
claims the benefit of U.S. provisional patent application No. 63/934,562 filed Dec. 9, 2025;
claims the benefit of U.S. provisional patent application No. 63/910,161 filed Nov. 3, 2025;
claims the benefit of U.S. provisional patent application No. 63/901,546 filed Oct. 18, 2025;
claims the benefit of U.S. provisional patent application No. 63/883,253 filed Sep. 17, 2025;
claims the benefit of U.S. provisional patent application No. 63/876,986 filed Sep. 6, 2025;
claims the benefit of U.S. provisional patent application No. 63/854,762 filed Jul. 31, 2025;
claims the benefit of U.S. provisional patent application No. 63/831,456 filed Jun. 27, 2025; and
claims the benefit of U.S. provisional patent application No. 63/784,040 filed Apr. 5, 2025.

### BACKGROUND OF THE INVENTION

### Field of the Invention

The invention relates generally to a patent model used to assist patent prosecution.

### Discussion of the Prior Art

### Problem

There exists in the art a need to enhance patent prosecution efficiency.

### SUMMARY OF THE INVENTION

The invention comprises a model assisted patent prosecution apparatus/system and method of use thereof.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a model assisted patent prosecution system;

FIG. 2 illustrates a patent prosecution agent/assistance system;

FIG. 3 illustrates a conception/inception testing system;

FIG. 4 illustrates entry formats of the inception testing system;

FIG. 5 illustrates an unofficial office action generator;

FIG. 6A illustrates a neural network model and FIG. 6B illustrates a neural network model optionally coupled to a database;

FIG. 7 illustrates training a model;

FIG. 8 illustrates patent model training;

FIG. 9 illustrates public database artificial intelligence model training;

FIG. 10 illustrates model training with published patents;

FIG. 11 illustrates model training with patent file wrappers;

FIG. 12 illustrates sequence training of a model;

FIG. 13 illustrates patent model inception output;

FIG. 14 illustrates novelty analysis of patent model generated/amended claims;

FIG. 15 illustrates inception testing with an unofficial office action and response thereto;

FIG. 16A and FIG. 16B illustrate an idea sorter and specification expander, respectively;

FIG. 17 illustrates model assisted patent prosecution;

FIG. 18 illustrates model assisted patent application analysis;

FIG. 19 illustrates a customer interface;

FIG. 20 illustrates an unofficial search;

FIG. 21 illustrates a priority date assessment system;

FIG. 22 illustrates multi-format code;

FIG. 23 illustrates model training/use;

FIG. 24 illustrates generation/use of an office action template;

FIG. 25 illustrates sections of an office action;

FIG. 26 illustrates an office action cover page;

FIG. 27 illustrates a claim summary;

FIG. 28 illustrates an office action summary;

FIG. 29 illustrates detailed actions of an office action;

FIG. 30 illustrates cited reference of an office action.

FIG. 31 illustrates prior tuning knowledge input into an artificial intelligence model;

FIG. 32 illustrates metadata sources;

FIG. 33 illustrates patent family metadata information;

FIG. 34 illustrates patent class metadata information;

FIG. 35 illustrates intra-patent metadata information;

FIG. 36 illustrates claim prosecution metadata information;

FIG. 37 illustrates claim-office action-response metadata information;

FIG. 38 illustrates claim element metadata information;

FIG. 39 illustrates selection of metadata from claims;

FIG. 40 illustrates metadata selection based on word rarity;

FIG. 41 illustrates metadata selection based on word prevalence;

FIG. 42 illustrates metadata selection with an algorithm;

FIG. 43 illustrates art, novelty, and/or CPC class determination;

FIG. 44 illustrates CPC class determination;

FIG. 45 illustrates keyword/metadata tagging CPC classes;

FIG. 46 illustrates filter CPC sub-category keyword/metadata tags;

FIG. 47 illustrates searching CPC sections;

FIG. 48 illustrates multi-level artificial intelligence models; and

FIG. 49 illustrates breadth controlled CPC searching.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises a method for prosecuting a claim of a set of claims in a patent application, comprising the steps of: inputting the claim as an input into a patent model, the patent model comprising an artificial neural network implemented on a computer system, the claim comprising at least a first element and a second element of a set of elements; assessing, with the patent model, a set of publications in a datastore for the presence of each of the first element and the second element; and reporting, as an output from the patent model, an unofficial office action comprising a claim novelty assessment for the claim, the claim novelty assessment comprising a first citation, of a first publication, of the set of publications in the datastore, citing: (1) a first snippet teaching the first element and (2) a second snippet teaching the second element.

### Overview

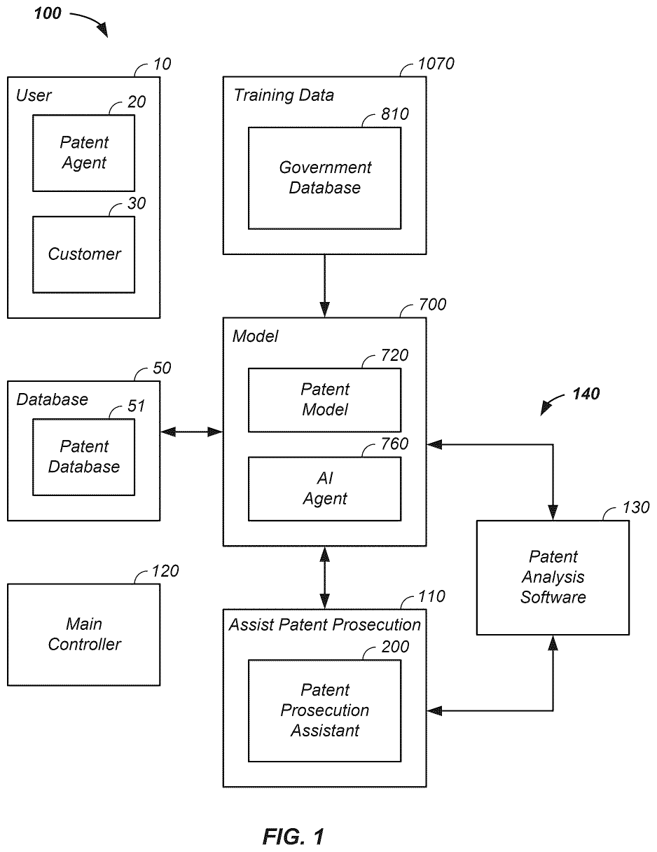

Referring now to FIG. 1, generally, a model assisted patent prosecution system 100/artificial intelligence assisted patent prosecution system is described. Generally, training data 1070, such as from a public government database 810 is used to train a model 700, such as a patent model 720, where the model optionally and preferably incorporates and/or is associated with an artificial intelligence (AI) agent 760 and/or a patent prosecution assistant 200. The model 700 is used in assisting patent prosecution 110, such as with the artificial intelligence agent 760 and/or the patent prosecution assistant 200. Optionally and preferably, the model 700 operates through use of a database 50, such as a patent database 51. Generally, a patent agent 20 interacts with any element of the model assisted patent prosecution system 100, such as with the training data 1070, patent database 51/model database, the model 700, and/or the patent prosecution assistant 200 and/or any elements thereof. The model assisted patent prosecution system 100 is further described, infra.

### Patent Prosecution

Still referring to FIG. 1, the model assisted patent prosecution system 100 is further described. Generally, patent prosecution includes all interactions between applicants and a patent office with regard to a patent application or a patent, such as all interactions between the patent agent 20 and the U.S. Patent and Trademark Office and/or examiners/employees/contractors thereof, where herein the patent agent 20 refers to any one or more of: an inventor, a client, a patent attorney/agent, and/or a computer algorithm/computer code/computer model. Herein, a customer 30 is anyone, any attorney/agent, any inventor, any company, any entity, and/or any computer code that interacts with the model assisted patent prosecution system 100. In one case, the patent agent 20 is an example of a customer 30, where the patent agent 20 and/or the customer 30 user interacts with the model assisted patent prosecution system 100, such as via an API and/or via a front end, as further described infra. For clarity of presentation and without loss of generality, the text herein optionally uses the clause patent agent 20 to refer to the customer 30 and/or, more generically, to a user 10 of the model assisted patent prosecution system 100. The user 10 is optionally a subject matter expert. Further, patent prosecution optionally and preferably involves any aspect of conception of an idea, which leads to inception testing of the idea and/or analyzing an idea in terms of patentability. Still further, patent prosecution optionally and preferably includes all patent preparation work, such as searching, drafting, and/or preparing a patent application and/or working with an allowed/issued patent, such as in handling/trading/selling the property and/or in legal proceedings. Examples of activities, phases, and importance of patent prosecution/the patent prosecution process are further described here.

In a first case, patent prosecution is a process of interacting with a patent office, such as the U.S. Patent and Trademark Office, to obtain patent protection for an invention, which encompasses drafting, filing, and negotiations to secure patent rights. Herein, for clarity of presentation and without loss of generality, the U.S. Patent and Trademark Office is used as an example of any patent office in any country/region, such as the European Patent Office and/or the Japanese Patent Office.

In the first case, patent prosecution generally includes any one or more elements of the entire process from the conception of a patent/the initial filing of a patent application to the point where a patent is either granted or abandoned. Some examples of key activities include:
conceptualizing an application;
determining patentability of the conceptualized idea(s);
drafting the application;
filing the application; and/or
responding to one or more office actions.

Several key activities of the patent prosecution process are further described here. Drafting the application generally includes preparing a detailed description of the invention, including claims that define the scope of the invention, and/or filing associated paperwork with the respective government office(s). Filing the application generally involves submitting the application and associated paperwork to a patent office. Responding to an office action generally involves responding to any patent examiner comment, objection, rejection, argument, and/or allowance and/or managing any aspect of the application, such as the title, abstract, specification, claims, and/or associated paperwork. The response/arguments include a range of activities, such as communicating law/precedent, clarifying remarks, and/or amending the claims, the figures, and/or the specification. Generally, patent prosecution has two phases, pre-grant (before a patent is issued) and post-grant (after a patent is issued). Successful patent prosecution secures intellectual property rights, such as for an applicant, inventor(s), business, and/or an institution.

### Patent Agent

Still referring to FIG. 1, herein the patent agent 20 is optionally a user 10, person, inventor, law firm and/or employees thereof, a patent attorney, a registered patent agent, a company/industry and/or employees thereof, a government employee, a government contractor, a patent examiner, and/or a person, but is optionally a program/bot/and/or an outside agent, AI agent, configured to interact with the model 700, such as directly through the artificial intelligence agent 760 and/or through interaction with the patent prosecution assistant 200.

### Artificial Intelligence Agent/Assistant

Still referring to FIG. 1, the artificial intelligence (AI) agent 760 and the patent prosecution assistant 200, such as associated with an artificial intelligence model, further described infra, are described. Generally, AI agents, such as the artificial intelligence agent 760 are autonomous and, as such, are capable of making decisions and taking actions independently to achieve goals. Generally, AI assistants, such as the patent prosecution assistant 200, are primarily reactive and are used to respond to user commands and to perform specific tasks. Here the artificial intelligence agent 760 is generally an AI agent and is optionally an AI agent with patent domain training. Agents and assistants are further described herein. Generally, herein, optionally any prosecution process described using the patent prosecution assistant 200 is optionally performed with the artificial intelligence agent 760 and vice versa. Patent domain training of the model 700 is optionally and preferably used with the artificial intelligence agent 760 and/or the patent prosecution assistant 200.

Still referring to FIG. 1, the artificial intelligence agent 760 is optionally:
autonomous/semi-autonomous with power to make decisions/take actions without constant user input;
proactive meaning having an ability to initiate actions to achieve a specific goal; and/or
designed to handle complex tasks, which are typically multi-step processes requiring reasoning and/or inference.

Still referring to FIG. 1, the artificial intelligence agent 760 is tasked to/equipped to prepare and/or prosecute a patent and/or a set of patents, as further described infra.

Still referring to FIG. 1, the patent prosecution assistant 200 is an example of an AI assistant. The patent prosecution assistant 200 is primarily tasked with/equipped to respond to user commands, such as from the patent agent 20. Generally, the patent prosecution assistant 200 is an AI assistant that is optionally a domain specific trained assistant tasked with providing patent related information as needed. The patent prosecution assistant 200 is optionally and preferably equipped with a user interface/patent agent interface, such as a chatbot interface and/or a voice interface.

In summary, AI assistants are reactive, performing tasks at request of the patent agent 20 and AI agents 760 are proactive, working autonomously to achieve a specific goal by any means at their disposal.

Still referring to FIG. 1, patent analysis software 130 is optionally used in place of the model 700 and/or in combination with the model 700, as further described infra. While, for clarity of presentation and without loss of generality, the model assisted patent prosecution system 100 is described in terms of artificial intelligence aided patent prosecution, traditional code is optionally used to assist patent prosecution with or without use of artificial intelligence and/or a model in patent prosecution. For example, artificial intelligence is described, infra, for generation of an unofficial office action. Herein, it is noted that traditional code is optionally used, such as in the patent analysis software 130, to generate an unofficial office action. Optionally and preferably traditional code and artificial intelligence are both used in the model assisted patent prosecution system in a blended code system 140, such as a two code system, a mixed code system, and/or a blended code system. Thus, for clarity of presentation and without loss of generality, while the invention is described in terms of artificial intelligence aided patent prosecution and/or model aided patent prosecution, traditional code, such as in patent analysis software 130, is optionally used in place of and/or in combination with any of the herein described techniques of an artificial intelligence aided patent prosecution and/or a model aided patent prosecution.

### Main Controller

Still referring to FIG. 1, an optional main controller 120/controller/system controller, is a localized communication apparatus, and/or a system for communication of information, which optionally and preferably comprises one or more subsystems stored on a client. The client is a computing platform configured to act as a client device or other computing device, such as a computer, personal computer, a digital media device, and/or a personal digital assistant. The client comprises a processor that is optionally in a physical container, such as a computer housing, and/or is coupled to one or more internal or external input devices, such as a mouse, a keyboard, a display device, a voice recognition system, a motion recognition system, or the like. The processor is also communicatively coupled to an output device, such as a display screen or data link to display or send data and/or processed information, respectively. In one embodiment, the communication apparatus is the processor. In another embodiment, the communication apparatus is a set of instructions stored in memory that is carried out by the processor.

The client optionally and preferably includes a computer-readable storage medium, such as memory/computer hardware. The memory includes, but is not limited to, an electronic, optical, magnetic, or another storage or transmission data storage medium capable of coupling to a processor, such as a processor in communication with a touch-sensitive input device linked to computer-readable instructions. Other examples of suitable media include, for example, a flash drive, a CD-ROM, read only memory (ROM), random access memory (RAM), an application-specific integrated circuit (ASIC), a DVD, magnetic disk, an optical disk, and/or a memory chip. The processor executes a set of computer-executable program code instructions stored in the memory. The instructions may comprise code from any computer-programming language, including, for example, C originally of Bell Laboratories, C++, C #, Visual Basic® (Microsoft, Redmond, WA), Matlab® (MathWorks, Natick, MA), Java® (Oracle Corporation, Redwood City, CA), and JavaScript® (Oracle Corporation, Redwood City, CA). Any element of the systems described herein is optionally implemented on computer hardware and/or computer software.

A quantum computer is optionally used to perform any task herein.

The main controller/controller/system controller comprises computer implemented code/an artificial intelligence system to control one or more sub-systems. The computer implemented code is programmed in any language by one skilled in the art of the subsystem and/or by a skilled computer programmer appropriate to the task. Herein, for clarity of presentation and without loss of generality, specific computer code is not presented, whereas computer code appropriate to the task is readily available commercially and/or is readily coded by a computer programmer with skills appropriate to the task when provided the invention as described herein.

Herein, an element and/or object is optionally manually and/or mechanically moved, such as along a guiding element, with a motor, and/or under control of the main controller.

Herein, the main controller 120 is optionally used to directly and/or indirectly interface, link to, and/or connect with any element of the model assisted patent prosecution system 100/artificial intelligence assisted patent prosecution system, such as the training data 1070, the patent database 51, the patent agent 20, the model 700, and/or the patent prosecution assistance 200 and/or any element(s) thereof, such as the AI agent 760.

Still referring to FIG. 1, elements of the model assisted patent prosecution system 100/artificial intelligence assisted patent prosecution system are further described, infra.

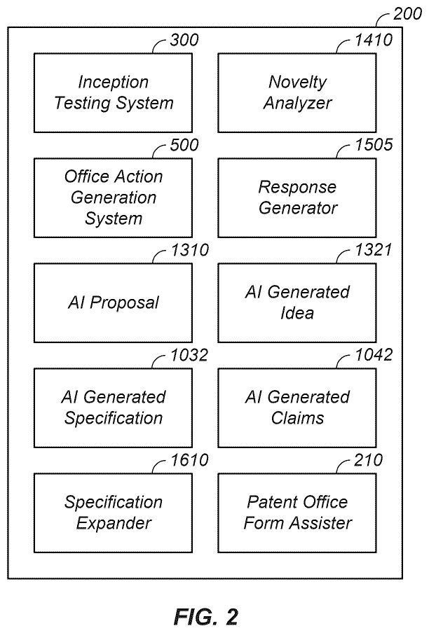

Referring now to FIG. 2, the patent prosecution assistant 200, which is optionally and preferably used in assisting patent prosecution 110 is further described. For clarity of presentation and without loss of generality, functions of the patent prosecution assistant 200 are described here. However, any of the functions/modules/uses of the patent prosecution assistant 200 are optionally performed with the artificial intelligence agent 760. Generally, the patent prosecution assistant 200 includes use of one or more steps/outputs/modules that aid the patent agent 20 in any aspect of patent prosecution. Examples of uses of the patent prosecution assistant 200 include use of/generation of any one or more of:
an inception testing system 300;
a novelty analyzer 1410;
an office action generation system 500;
a response generator 1505;
an artificial intelligence proposer 1310;
an artificial intelligence generated idea 1321;
an artificial intelligence generated specification 1032;
an artificial intelligence generated claim 1042;
a specification expander 1610; and/or
a patent office form assister 210.

Use of the patent prosecution assistant 200 is further described infra. However, notably, any of the elements presented in FIG. 2 are optionally and preferably used by the artificial intelligence agent 760, such as in an autonomous/semi-autonomous manner. For instance, the specification expander 1610 is optionally run manually by the patent agent 20, is run autonomously by the artificial intelligence agent 760, and/or is a mix of the two where the patent agent assigns loops to the artificial intelligence agent 760 and/or reviews output/progress of the artificial intelligence agent, as further described infra.

### Conception/Inception Testing

One key element of patent prosecution is conceiving an idea and optionally and preferably reviewing patentability of the idea early in a patent prosecution process.

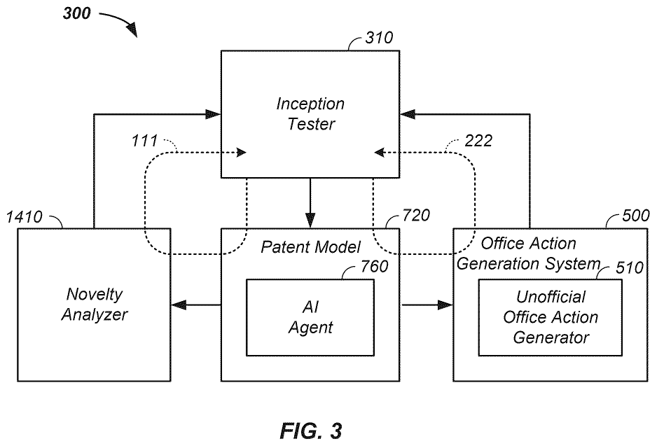

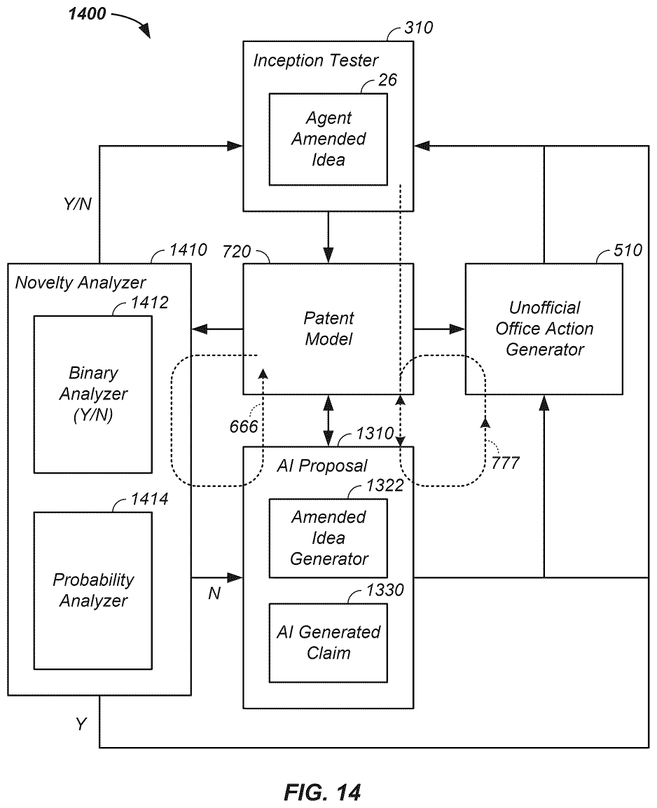

Referring now to FIG. 3, an inception testing system 300 is illustrated. Conception of an idea is typically followed by inception and/or implementation of the idea. Herein, an inception tester 310 feeds an idea, such as from the patent agent 20 and/or as described later from an artificial intelligence patent proposal 1310, into the patent model 720 to yield a patentability analysis, where the patent model 720 optionally and preferably incorporates a neural network model, as further described infra. Generally, in a first process 111, the patent model 720 and/or one or more of the artificial intelligence agent 760 and/or the patent prosecution assistant 200 associated therewith, optionally and preferably feed the idea into/process the idea in/with a novelty analyzer 1410, which analyzes novelty of the idea and responds to the patent agent 20/inception tester 310 with a novelty outcome, such as a yes response indicative of novelty or a no response indicative lack of novelty, which is an outcome from a binary analyzer 1412 of the novelty analyzer and/or returns a probability of novelty, such as with a probability analyzer 1414, which is further described in FIG. 14. Thus, the first process 111 yields a novelty assessment opinion, such as in terms of a Y/N and/or a probability response. The first process 111 is optionally and preferably repeated/iterated, such as through a modification of the idea presented by the inception tester 310 and/or as described later by an artificial intelligence system to the patent model 720.

Still referring to FIG. 3, the inception testing system 300 is further described in terms of an optional and preferable second process 222. While the first process 111 yields a novelty opinion/result, it does not necessarily indicate why. For instance, the first process 111 might return some related art, but might not analyze the related art. In the second process 222, the idea from the inception tester 310, such as an idea described above in the first process, is sent to the patent model 720, where the artificial intelligence agent 760 and/or the patent prosecution assistant 200 analyze the idea with an optional office action generation system 500 aspect of the patent model 720 and/or optionally with an app/code designed to generate an unofficial office action, such as with an unofficial office action generator 510, such as a predicted office action generator. Herein, the unofficial office action, refers to an expected office action and is optionally referred to as a predicted office action and/or an unofficial patent office action. The unofficial office action generator 510 optionally and preferably generates and provides back to the inception tester 310/patent agent 20 an expected office action, and unofficial office action, and/or a predicted office action. The unofficial office action contains any one or more elements of an office action from a government patent examiner, such as cited art/patent class as it applies to any aspect of article 35 of the United States Code (35 U.S.C.), article 37 of the Code of Federal Regulations (35 C.F.R.), case law, and/or any element of the Manual of Patent Examining Procedure (MPEP). For instance, the unofficial office action 2510 optionally includes a 35 U.S.C. § 102 and/or a 35 § U.S.C. 103 response that indicates why the idea is novel/not novel in terms of anticipation and/or novelty in terms of cited art, which greatly aids the patent agent 20 in determining whether or not to pursue the idea in patent prosecution, such as whether or not to file the application in the first place or to amend the application prior to filing. Typically, a yes from the novelty analyzer 1410 and more typically a yes result from analysis of the unofficial office action supports a decision by the patent agent 20 and/or an automated version thereof, described infra, to pursue patent prosecution of the idea, whereas, a no result and/or a well-supported rejection of the idea in the unofficial office action leads the patent agent 20 to try a new idea with the inception tester 310 in a manual and/or in an automated fashion, as further described infra. A response from the artificial intelligence model optionally and preferably includes one or more snippets, where the snippet is optionally a direct quote from a reference, such as a patent specification, and/or is a concise summary/overview/answer, such as derived from multiple sources.

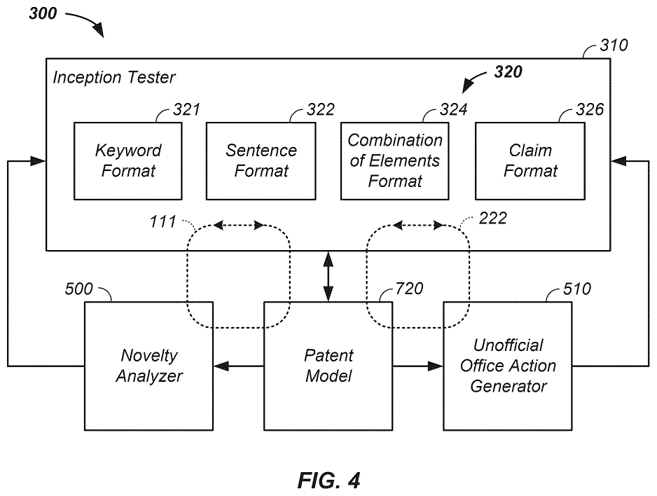

Referring now to FIG. 4, the inception testing system 300 is further described. Optionally, the inception tester 310 uses input idea types 320 and/or styling. For instance, the patent agent 20/customer 30 provides the idea in an inception input form 320, such as keywords 321 in a keyword format, a sentence format 322, a combination of elements format 324, and/or a claim format 326. Since both the first process 111 and the second process 222 analyzes the idea in terms of input, the clearer the input, the clearer the likely result, in terms of a novelty assessment. For instance, a sentence format 322, such as from a lay user, could present the idea in a rough form that may lack legal accuracy and/or legal precision, which is likely to yield a result that is not as accurate as input of the idea in the form of a bullet list, such as provided in a combination of elements format 324. The combination of elements format is more in-tune with an patent examiner's assessment of novelty, where novelty is often assessed in terms of a combinations of elements. Still further, if the idea is presented in a claim format 326, then the patent model 720 is provided with, preferably, exact relationships between the claim elements/claim steps. Thus, the format of expression of the idea, such as with enhanced effort put into the expression in terms of a formatted claim, leads the patent model 720 and/or the unofficial office action generator 510 to likely yield a more accurate and/or a more precise unofficial office action, which allows the patent agent 20 to make a more informed decision as whether or not to pursue patent prosecution of the idea and/or to feed another, optionally highly related but slightly modified, version of the idea into the inception testing system 300.

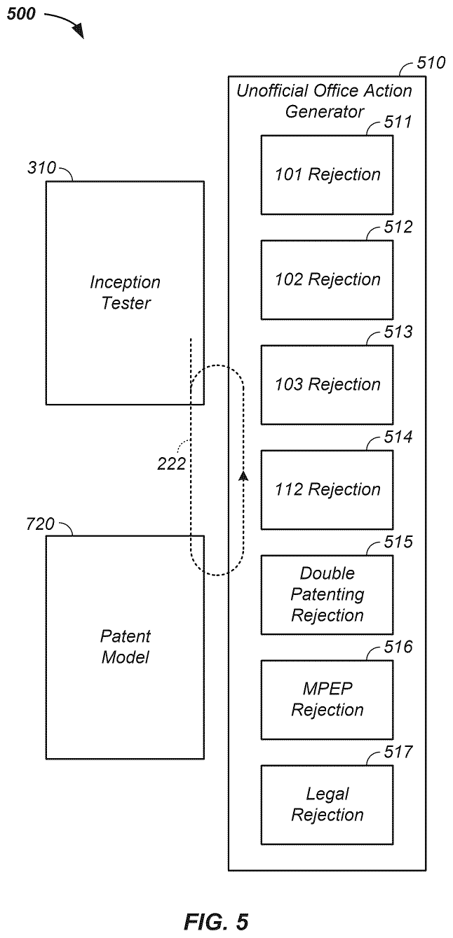

Referring now to FIG. 5, the office action generation system 500 is further described. The office action generation system 500 is optionally used by a patent examiner to aid in generation of an office action and/or to simply generate an office action. However, for clarity of presentation and without loss of generality, herein the office action generation system 500 is used to generate an unofficial office action with the unofficial office action generator 510, such as in the inception testing system 300 for use by the agent 20 and/or for use by the model 700.

Still referring to FIG. 5, the office action generation system 500 takes an idea, such as from the inception tester 310, in any format, such as in the claim format 326, and analyzes the idea in terms of patentability. Optionally and preferably, the unofficial office action generator 510 performs a search, such as based on one or more classes and/or one or more subclasses of identified related art/related art field(s)/classes, to yield a search result. Optionally, these fields of use, classes, and/or subclasses are from one or more national and/or worldwide databases. Herein, for clarity of presentation and without loss of generality, the search is optionally and preferably run with and/or without the international databases and/or is run with/without a search of the patent database 51 or a sub-section therein. A search on a subsection of the patent database 51 allows for a targeted search in generation of the unofficial office action. The patent database 51 optionally includes industry/academic private information, trade secrets, reports allowing a targeted analysis of a conceived idea of the industry/academic institution.

Still referring to FIG. 5, the unofficial office action generator 510 generates any element of a typical office action provided by a patent examiner. For instance the unofficial office action generator 510 provides, in terms of the inception idea and the search results, one or more of:
an objection, such as to capitalization of a first word of a claim, a claim not ending in a period, and/or a typo graphical error;
a 35 U.S.C. 101 rejection 511;
a 35 U.S.C. 102 rejection 512;
a 35 U.S.C. 103 rejection 513;
a 35 U.S.C. 112 rejection 514;
a double patenting rejection 515;
a double patent objection;
an MPEP rejection 516 based on one or more sections of the MPEP;
a MPEP objection; and/or
a legal rejection 517,
   where the MPEP refers to the Manual of Patent Examining Procedure, a U.S. patent office tool with equivalents in other countries. Optionally, the unofficial office action generator 510 outputs the unofficial office action in a form matching that of and/or tracking that of an actual office action from a patent examiner.

Still referring to FIG. 5, any element of generation of the unofficial office action is optionally and preferably included in any aspect of the second process 222, described supra, such as in a loop of testing a series of ideas in with the inception tested 310.

### Model

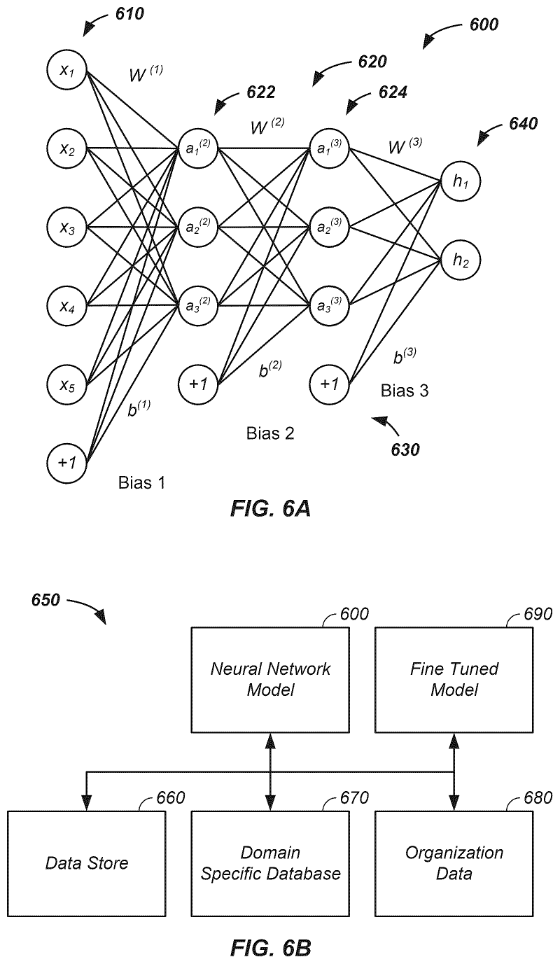

Referring now to FIG. 6A, an exemplary AI model, such as a neural network 600 is illustrated. Generally, the neural network contains an input layer 610, a set of one or more hidden layers 620, a set of biases 630, and an output layer 640. Here, five inputs are illustrated (x₍₁₋₅₎), where any number of inputs, n, are optionally used, where n is positive integer. The specification herein describes how to generate the inputs, such as with the training data 1070, the patent database 51, and/or from an AI generated patent element. Two hidden layers, a first hidden layer 622 and a second hidden layer 624, are illustrated of n optional hidden layers, where n is optionally a positive integer greater than 0, 1, 2, 5, or 10. The set of biases 630 optionally includes a bias for the input layer 610 and/or any hidden layer. The output layer 640 yields the AI model predictions 630, described throughout.

Still referring to FIG. 6A and referring now to FIG. 6B, optionally, the AI model is an existing AI model, such as a large language model that is optimized/applied to a specific task with a database, like a patent database, where output from the AI model, linked to the database, is optionally and preferably fine-tuned, such as a Gemini/Google model tuned to patent applications, such as with data at least partially extracted from file wrappers.

Referring now to FIG. 6B, a hybrid model 650 is illustrated that includes at least a neural network model 600 couple to and/or incorporating into the hybrid model data in a data store 660; domain specific data, such as in a domain specific database 670; organization data 680; and/or information in the database 50. For instance, the patent information described throughout this document is optionally included in training of a main artificial neural network model, such as in a large language model. However, the information described throughout this document is optionally acted on by a main/underlying artificial neural network model, such as where the main/underlying artificial neural network model is used to extract information upon request from the database 50, the patent database 51, a domain specific database 670, and/or organization data 680. For clarity of presentation and without loss of generality, an example of organization data 680 is data in and engineering, science, and/or business report and/or collection thereof. For instance, Gemini from Google is lined to a data store 660, where organization data 680 is optionally coupled to the neural network model 600 directly and/or via a data store 660. Optionally, neural network model 600 is fine-tuned, such as in a fine tuned model 690 linked to/in the neural network model 600. An example of fine tuning output is output to a query like “Is claim 1, following novel”, where after analysis of claim 1 by the model, output is in a preferred form, such as any of:
Claim 1 stands rejected under 35 U.S.C. § 101;
Claim 1 stands rejected under 35 U.S.C. § 101 as (insert element of MPEP);
Claim 1 stands rejected under 35 U.S.C. § 102 in view of (insert art description);
Claim X stands rejected under 35 U.S.C. § 102 in view of (insert art description) as Claim X (element 1) is found in (art at page m₁/line n₁) and Claim X (element n) is found in (art at page m₂/line n₂);
Claim X stands rejected under 35 U.S.C. § 103 in view of (insert first art description) in view of (insert second art description); and/or
claim 1 stands rejected under 35 U.S.C. § 112 as (insert rule/reason).

While, for clarity of presentation and without loss of generality, only a limited number of fine tuned rejections are presented here, any standard response from the Manual of Patent Examining Procedure is optionally used as a form of a trained response from the fine-tuned model 690. Similarly, the fine tuned model is optionally used to present information in a format of an office action, such as described infra.

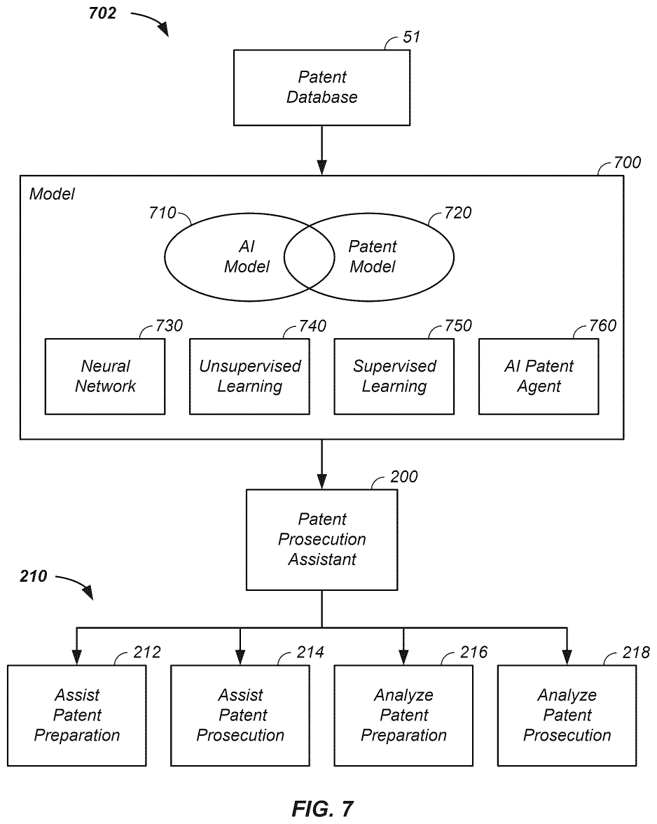

Referring now to FIG. 7, an example of model training 702 is illustrated. Generally, the patent database 51 and/or the training data 1070 is used to train the model 700, such as an artificial intelligence model 710 and/or the patent model 720, where the patent model 720 is optionally and preferably an example of an AI model. In the case of an artificial intelligence model 710, the model 700 includes a neural network 730, which is trained using unsupervised learning 740, such as by being fed data from the patent database 51 and/or the government database 810, and/or with supervised learning 750, such as further described infra. Output from the model 700, such as via the patent prosecution assistant 200/the artificial intelligence agent 760 is optionally in the form a patent prosecution aid 210, such as in the form of one or more of: analyzing/assisting patent preparation 212, analyzing/assisting patent prosecution 214, assisting patent preparation 216, assisting patent prosecution, and/or in any of the aid methods described herein, such as inception novelty analysis.

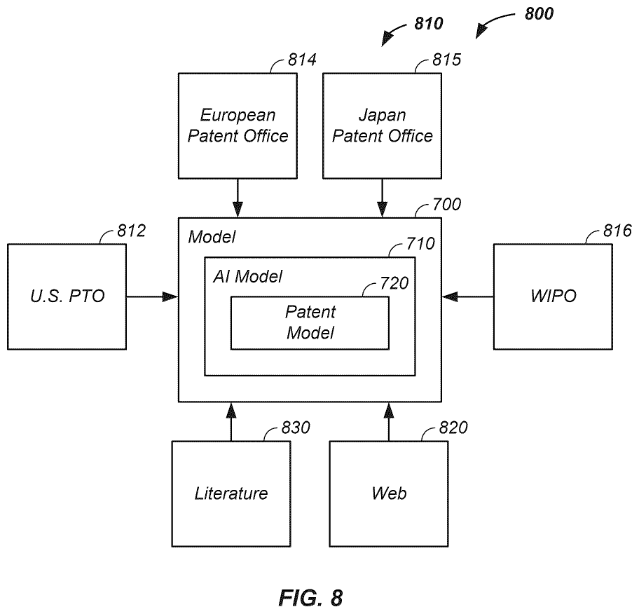

Referring now to FIG. 8, model training 702 is further described. In this example, patent model training 800 is illustrated with government databases 810, such as from the U.S. Patent and Trademark Office 812 (USPTO), the European Patent Office 814 (EPO), the Japanese Patent Office (JPO), the World Intellectual Property Organization 816 (WIPO) and/or the like, such as other government patent offices. FIG. 8 also illustrates optional training of the model 700, the artificial intelligence model 710, and/or the patent model 720 with data/information from the Web 820 and/or from the literature 830. The model 700 is optionally a known model type, such as a large language model and/or a model using figure/pictures and/or a combination thereof. Notably, the patent model 720 is optionally and preferably a model that includes an emphasis on patent domain data.

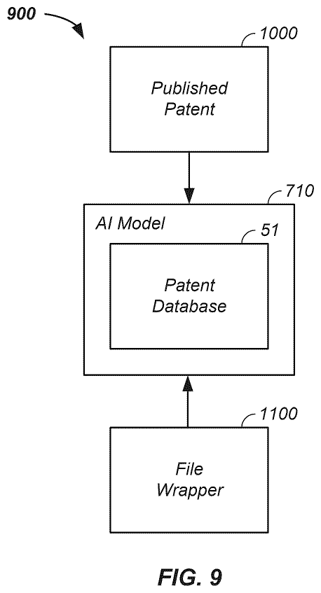

Referring now to FIG. 9, the model 700, such as the artificial intelligence model 710 and/or the patent model 720, is optionally trained with published data 900/public data, such as published patents 1000 and/or file wrappers 1100, such as after a non-public period based on patent office rules. A file wrapper 1100, also referred to as a patent file wrapper, a prosecution history, and/or a file history, is the official record of all documents and correspondence related to a patent application as it moves through a government agency, such as the U.S. Patent and Trademark Office. Generally, a file wrapper is a written record in a patent office of the application and negotiations for a patent preceding the issuance of the patent.

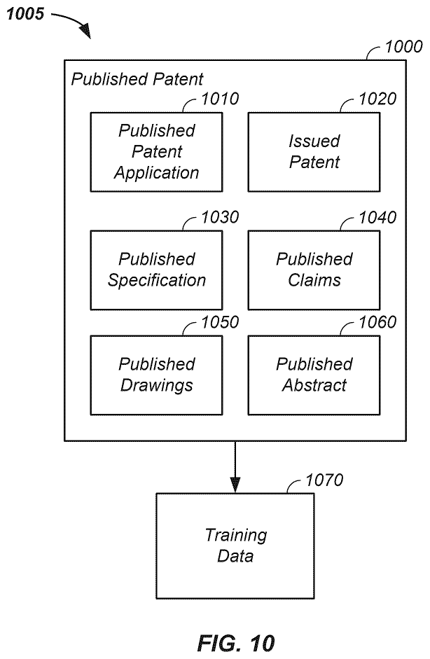

Referring still to FIG. 9 and referring now to FIG. 10, lifting/scraping published data 1005 from the published patent 1000 is further described. Examples of published patents 1000 include a published patent application 1010 and/or a published issued patent 1020. Information within published patent includes at least: a published specification 1030, which includes a title, prior art, and linked patents; published claims 1040, published drawings 1050/drawing sheets; and/or a published abstract 1060. Generally, any information/data/text/drawing in the published patent is optionally incorporated in the training data 1070. The training data 1070 is optionally updated on a regular basis as new published patents 1000 become available, such as an update in a time period of less than 1, 2, 5, 7, 8, 10, 30, 40, 60, 180, of 367 days.

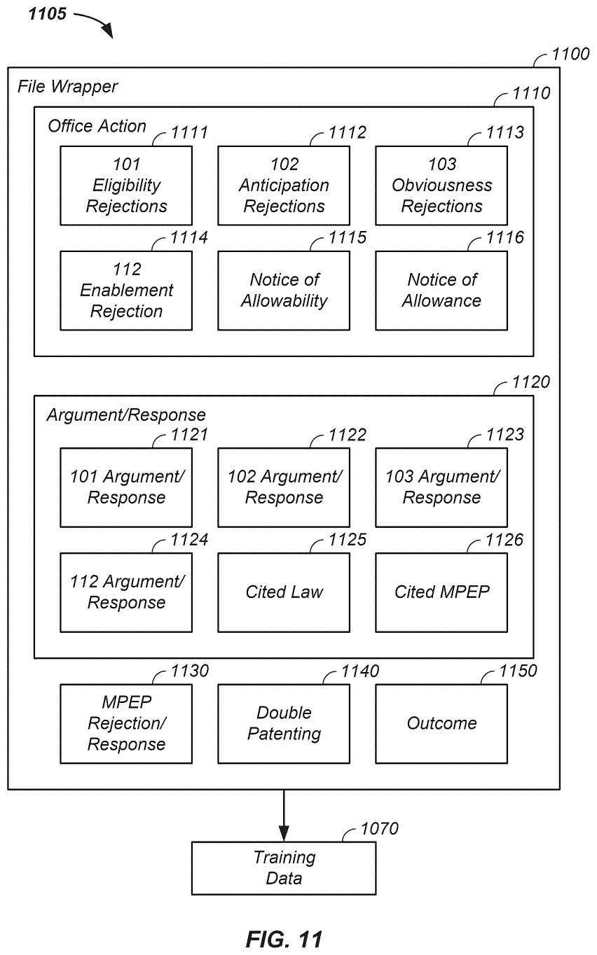

Referring still to FIG. 9 and referring now to FIG. 11, lifting/scraping file wrapper data 1105 from the file wrapper 1100 is further described. Examples of data/information/text/drawings from the file wrapper includes any information from an office action 1110, an argument/response 1120, an MPEP rejection/response 1130, any double patenting 1140 objection/rejection/response, and/or notably any outcome 1150, such as a patent examiner reaction/decision based on any element of a previous office action 1110 and any element of the argument/response 1120 as related to a claim. Examples of information from the office action(s) used in training the model 700, used in the training data 1070, and/or used in the patent database 51 include any one or more of: a 35 U.S.C. § 101 eligibility rejection 1111, a 35 U.S.C. § 102 anticipation rejection 1112, a 35 U.S.C. § 103 obviousness rejection 1113, a 35 U.S.C. 112 enablement rejection 1114, a notice of allowability 1115 for one or more claims, and/or a notice of allowance 1116 for any one or more claims, where the cited rejections refer to any one or more section of the 35 U.S.C. code, 37 C.F.R. code, and/or any section and/or paragraph of the MPEP. Examples of arguments/responses 1120 include any one or more of: a 35 U.S.C. § 101 argument/response 1121, a 35 U.S.C. § 102 argument/response 1122, a 35 U.S.C. § 103 obviousness rejection 1123, a 35 U.S.C. § 112 argument/response 1124, cited law 1125, and/or a cited MPEP 1126 section/paragraph/element, and/or a snippet from a patent file wrapper element, such as a drawing, publication, and/or an abstract, where the snippet is optionally from a published element of the patent file wrapper and/or from a publication.

### Sequence Training

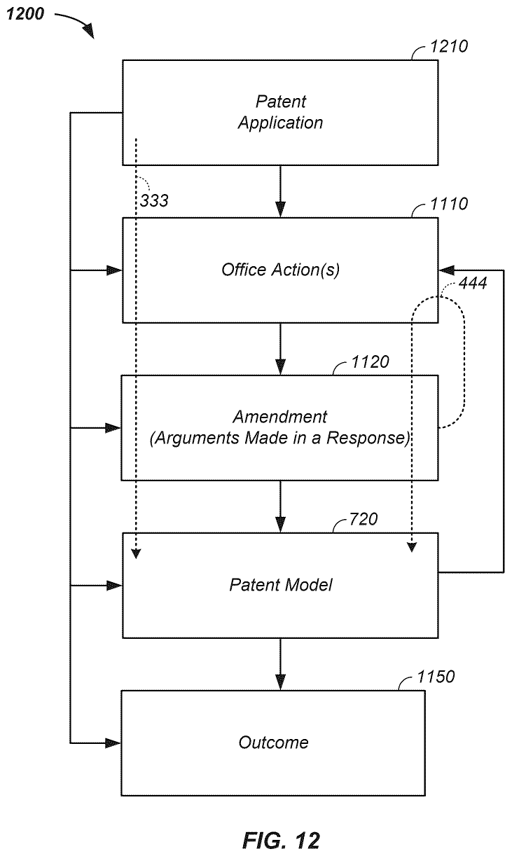

Referring now to FIG. 12, sequence training 1200, of the AI model 710, such as in the supervised learning 750 process, is described. Generally, the file wrapper 1100 contains many examples of sequential actions, such as in a third process 333 that includes a series of steps in which: (1) claims are presented, such as in a patent application 1210; (2) the claims are analyzed, such as in an office action 1110; and (3) arguments/amendments are made in a response 1120, where (4) an outcome is determined 1150, such as in a subsequent office action/notice of allowance. In a fourth process 444, the claims from the patent application are simply replaced with a current claim set the arguments/amendments made in the response 1120, which again results in an outcome 1150 in a subsequent office action/notice of allowance. The fourth process 444 repeats with each subsequent office action for a given patent application in the associated file wrapper. Thus, as outcome training benefits training of an AI model 710, such as with supervised learning 750, the claims, examination, response sequence with an outcome, as determined from the file wrapper 1100 is an optional and preferable method of training the AI model 710, such as the patent model 720. Notably, even private forms of the file wrapper are available to specific inventors/patent attorneys linked to the pending patent and are thus available for training of the patent model 720 by an industry/a law form for use by that industry/law firm. For example, a large law firm might have access to greater than 100, 1000, or 10,000 currently private file wrappers for use in training. Naturally, the private data used in training should not reveal details in the form or output from the AI model 700 outside of the industry/the law firm, but may be helpful in terms of drafting new ideas/patents. Further constraints to related attorneys in the law firm are optionally implemented to avoid conflicts of interest between clients.

### Ideas/Conception/Inception

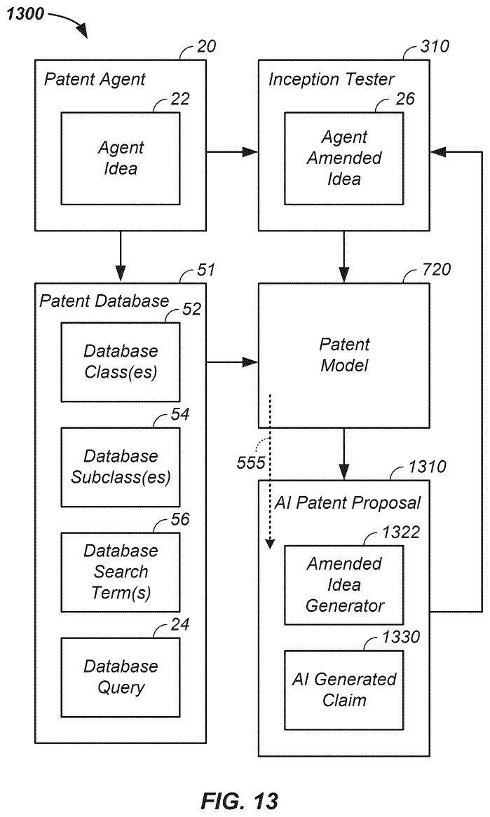

Referring now to FIG. 13, an artificial intelligence conception/inception system 1300 is described. Again, herein, conception is coming up with an idea and inception is at least in part taking the conceived idea and testing it for patentability. Generally, in a fifth process 555, the patent model 720, such as the patent prosecution assistant 200, generates an idea in/with an artificial intelligence patent proposal system/module/app 1310 with an amended idea generator 1322, which optionally and preferably takes an idea, such as from a claim and/or from an earlier claim, and modifies the idea, such as to form a slightly new idea, a new idea, and/or an artificial intelligence generated claim 1330. Similarly, the amended idea generator 1322 optionally operates with information from the patent database 51 to look for ideas not yet conceived of and/or not yet claimed. Similarly, optionally the patent agent 20 has an agent idea 22 that is fed into the artificial patent proposal system 1310 and the agent idea is used to generate an idea in the amended idea generator 1322. Optionally and preferably, the artificial intelligence generated claim is passed back through the inception tester 310, such as described in the first process 111 and/or the second process 222 and/or back through the patent model 720 to result in a series of amended and tested artificial intelligence generated claims.

Still referring to FIG. 13, any of the first, second, third, and fifth processes 111, 222, 333, 555 optionally search the patent database 51 using database classes 52, which is also referred to as a patent class; database subclasses 54, which is also referred to as a patent subclass; database search terms 56, and/or a database query 24, where the search terms and/or classes optionally incorporate any government defined class/subclass, such as those used by the U.S. Patent and Trademark Office.

Still referring to FIG. 13, a patent class/a database class 52 optionally refers to detailed text within a patent classification system, such as the Cooperative Patent Classification (CPC) or the International Patent Classification (IPC), that describes the specific subject matter of a particular class or subclass. These definitions explain the technical area and the specific processes, structures, and functions of the inventions categorized within that class, serving as a crucial tool for patent examiners and users to accurately search and organize patent documents. For instance, classes exist in classification systems. For example:
1. Classification Systems: Patent offices worldwide use classification systems like the CPC, which is jointly developed by the EPO and USPTO, and the IPC to categorize inventions.
2. Hierarchy: Patent classification systems are hierarchical, with classifications divided into broad sections, then more specific classes, subclasses, and further subdivisions.
3. Unique Codes: Each class and subclass has a unique alphanumeric identifier.
4. Detailed Descriptions: The class definition provides a comprehensive explanation of what is covered within that specific identifier, often going into greater detail than the brief title.
5. Classification: a patent document is assigned a classification symbol that associates it with the appropriate class and subclass, based on its subject matter.

Referring now to FIG. 14, a hybrid AI idea-novelty analyzer system 1400 is described. For example, in a sixth process 666 the novelty analyzer 1410 analyzes an idea, as described supra, and the artificial intelligence proposal system 1310 modifies the idea, such as in a loop until the novelty analyzer 1410 yields a yes response and/or yields a novelty probability above a threshold, as described supra. Key in the sixth process 666 is: (1) that the artificial intelligence proposal system 1310 creates an idea and/or (2) the amended idea generator modifies an idea, from the agent 20 and/or from an earlier iteration of the sixth process. The sixth process 666 optionally and preferably couples with any element(s) of the first, second, third, and/or fifth processes 111, 222, 333, 555, which allows agent amended ideas 26; use of the unofficial office action generator 510 in analysis of an AI conceived; and/or and AI amended idea. Similarly, in a seventh process 777, the AI conceived and/or an AI amended idea is fed into the patent model 720 and through the unofficial office action generator 510, or vice versa, in analysis of the idea. Again, the seventh process 777 optionally and preferably uses any element(s) of the first, second, third, fifth, and/or sixth processes 111, 222, 333, 555, 666.

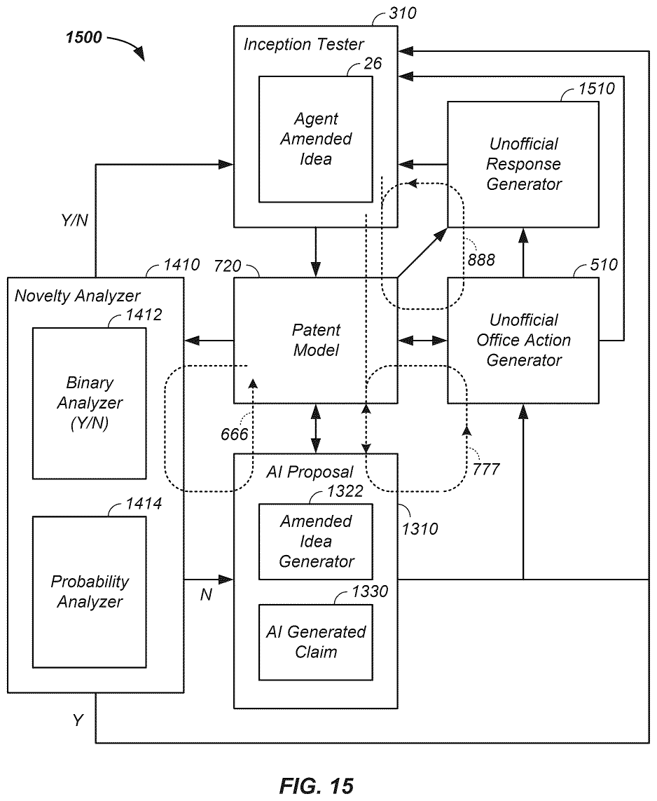

Referring now to FIG. 15, a hybrid inception tester-predicted response generator system 1500 is illustrated. Generally, in an eighth process 888, an unofficial response generator 1510 generates a response to an office action, such as where the office action is provided by a patent office and/or, as illustrated, is generated responsive to an outcome from the unofficial office action generator 510, as described supra. Thus, as illustrated, in the above described inception testing processes, not only is an idea tested with an unofficial office action, but a predicted response is provided for analysis of likelihood of patentability of the current claim/iterated claim, such as by the patent agent 20 and/or by the patent model 720. Thus, even if rejections are formed in an unofficial office action by the unofficial office action generator 510, an analysis of the strength of the rejections(s) is provided in the form of a predicted response generated by the unofficial response generator 1510 for use in a patentability analysis.

Generally any element in the first process 111, the second process 222, the third process 333, the fifth process 555, the sixth process 666, the seventh process 777, and/or the eighth process 888 is used in any one or more of the other processes.

### Specification

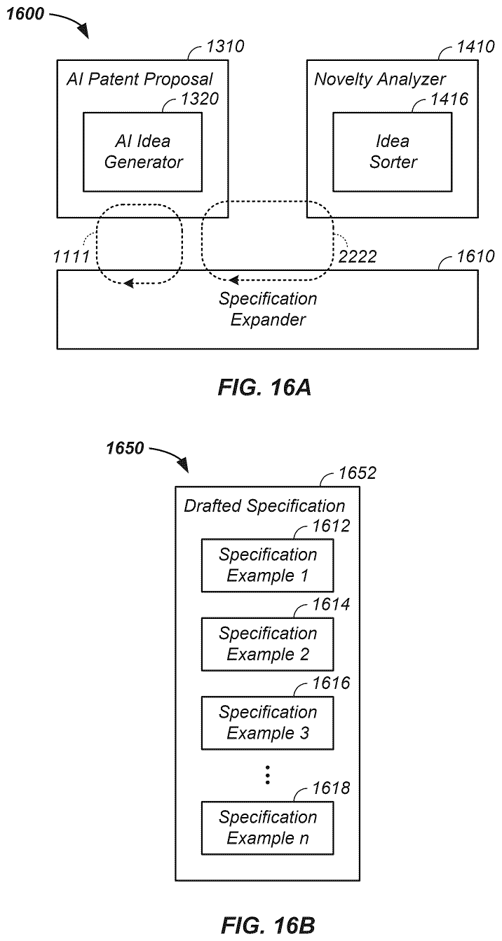

Referring now to FIG. 16A and FIG. 16B, a specification expander sorter system 1600 is illustrated that optionally couples with a specification expander system 1650. Generally, in a first specification process 1111, the artificial intelligence patent proposal system 1310 and/or the artificial intelligence idea generator 1320 thereof iteratively generates ideas that are sent one at a time and/or in batches to a specification expander 1610, described supra. In a second specification process 2222, the artificial intelligence patent proposal system 1310 and/or the artificial intelligence idea generator 1320 thereof iteratively generates ideas that are sent one at a time and/or in batches to the novelty analyzer 1410. The novelty analyzer is optionally linked with any of the first through eighth processes, described supra. As illustrated, the novelty analyzer 1410 incorporates an idea sorter 1416. The idea sorter ranks the ideas from the idea generator, such as with the above described analysis techniques, and sends a subset to the specification expander. For example, the ranking is optionally based on output of the novelty analyzer 1410, unofficial office action generator 510, and/or the unofficial response generator 1510 and/or an interaction with the patent agent 20. A top set percentage of the ideas are optionally kept, such as with a percentile ranking of greater than 10, 25, 50, 75, 90, 95, 96, 97, 98, or 99%. The specification expander 1610 then optionally and preferably adds selected ideas, such as from the top sorted ideas, to the specification. As illustrated, an example is added to the specification for each selected idea, such as a first specification example 1612 is added for the first idea, a second specification example 1614 is added for the second example, a third specification example 1616 is added for the third example, . . . , and an n^{th} specification idea 1618 is added for the n^{th} idea, where n is a positive integer greater than 1, 10, 100, or 1000. However, the selected ideas are optionally added to the specification in any manner.

For clarity of presentation and without loss of generality, several non-limiting examples are provided to further illustrate the specification expander and/or the model assisted patent prosecution system 100.

### Example I

In a first example, the above described artificial intelligence idea generator 1320 generates greater than 10, 100, 1000, or 10,000 ideas a day. For example, the artificial intelligence idea generator 1320 generates 100,000 ideas a day and the idea sorter 1416 selects a percentage less than or equal to 100, 90, 80, 70, 60, 50, 40, 30, 20, or 10 percent of the generated ideas, such as 1000 ideas a day for incorporation into the drafted specification 1652, which is optionally referred to as the filed specification or simply the specification. At 100,000 ideas a day, if a new drafted specification were generated daily and filed daily for a period of one year, the system would process 36.5 million ideas per year and file 365,000 ideas per year in 365 specifications, where filing fees, at $100/provisional patent, are only $36,000 a year and are coupled into a single utility patent for $2000. The patents could be linked as continuation-in-part applications. Thus, 365,000 ideas per year are provided with initial filing dates, which have extreme value in a first-to-file patent system.

### Example II

In a second example, the first example is detailed in terms of a pharmaceutical drug. A first molecule, such as with a carbon, nitrogen, and an oxygen each separated from each other by a number of carbons is to be protected. In each iteration of the artificial intelligence idea generator, the number of carbons is changed, aliphatic chain lengths are altered, carbon branching points are introduced, aromatic compounds are introduced, R₁ groups are added to nitrogen and/or to the oxygen, R₂ groups are added, R₁ to nitrogen and R₂ to the oxygen and vice versa, the R₁ and/or the R₂ group is modified, and so on until for a given proposed drug to be tested thousands of optional molecules are presented in the specification and filed, such as in a given day of the year. The process repeats for other candidate drugs on subsequent days of the year. Again, in a first-to-file system gaining the filing date before a competitor yields a competitive advantage and the expense is low as the system is optionally and preferably automated and/or reviewed by as few as zero or one patent agent 20, such as after the specification is already conceived/written/prepared/reviewed in terms of novelty/sorted by the AI systems described herein.

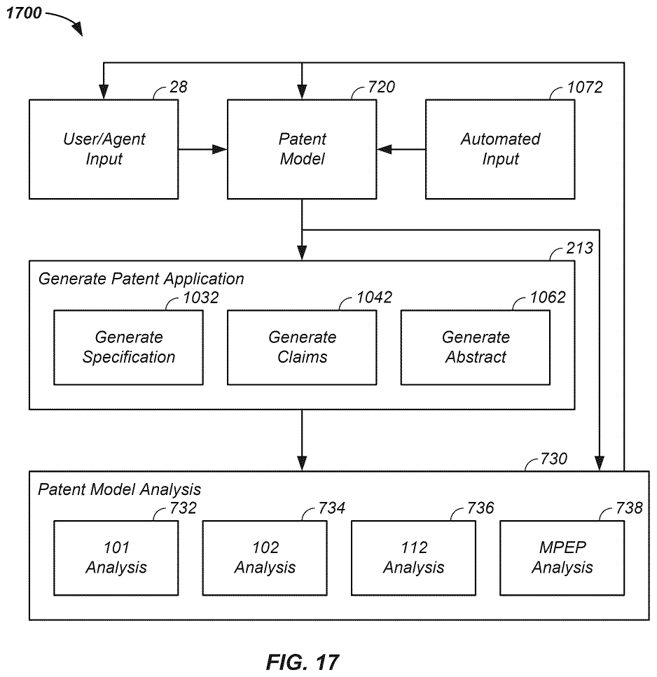

Referring now to FIG. 17, an AI-assisted patent testing/preparation system 1700 is illustrated. Generally, a user/agent input 28 and/or an automated input 1072 is provided to the patent model 720. Examples of inputs are any one or more of: a patent disclosure, a patent idea, an idea, a report, a business plan, a claim, claim ideas, and/or a drawing. The patent model 720 then generates an outcome, such as: generation of a patent application 213 and/or a part thereof, such as: generating a specification 1032 and/or part thereof, generating claims 1042, generating an abstract, and/or generating a drawing. Optionally, the patent model 720 analyzes the claim/claim idea, as further described supra. The patent model 720 optionally and preferably analyzes the generated claims and/or analyzes the provided claim/claim ideas with a patent model analysis system 730, such as in terms of: a 35 U.S.C. § 101 analysis 732, 35 U.S.C. § 102 analysis 734, 35 U.S.C. § 103 analysis 735, a 35 U.S.C. § 112 analysis 736, and/or a MPEP analysis 738, which references any section of the Manual of Patent Examining Procedure.

### Example III

Referring now to FIG. 17, a third example of an AI-assisted patent testing/preparation system 1700 is illustrated. As illustrated, a patent agent 20 and/or an automated agent input 1072 idea is generated and the idea is optionally tested and/or drafted and tested in an iterative manner, optionally testing large numbers of ideas rapidly with an Article 35 U.S.C. § 101, 102, and/or 103 analysis in terms of an MPEP analysis and computer and/or agent found art.

### Example IV

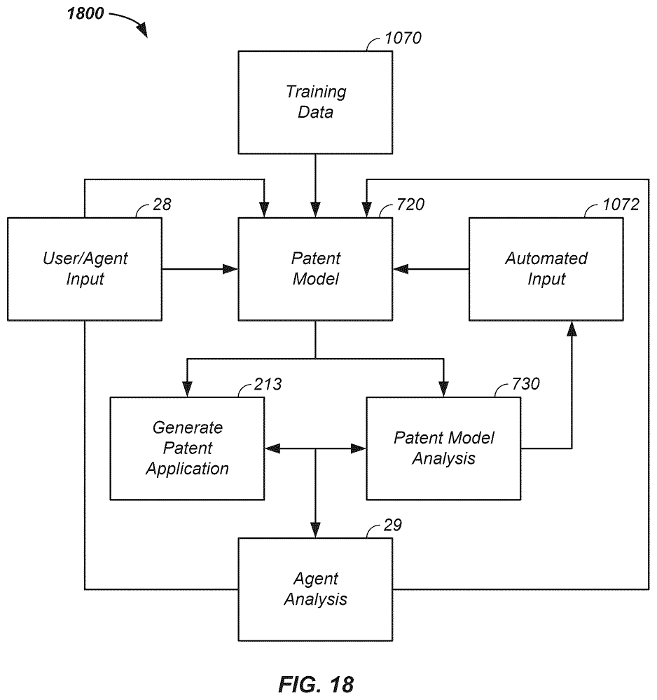

Referring now to FIG. 18, a fourth AI-assisted patent system 1800 is illustrated. FIGS. 17 and 18, along with the processes illustrated supra, illustrate that multiple pathways exist, for conceiving, testing, analyzing, drafting, and/or assisting in patent prosecution, using the patent model 720.

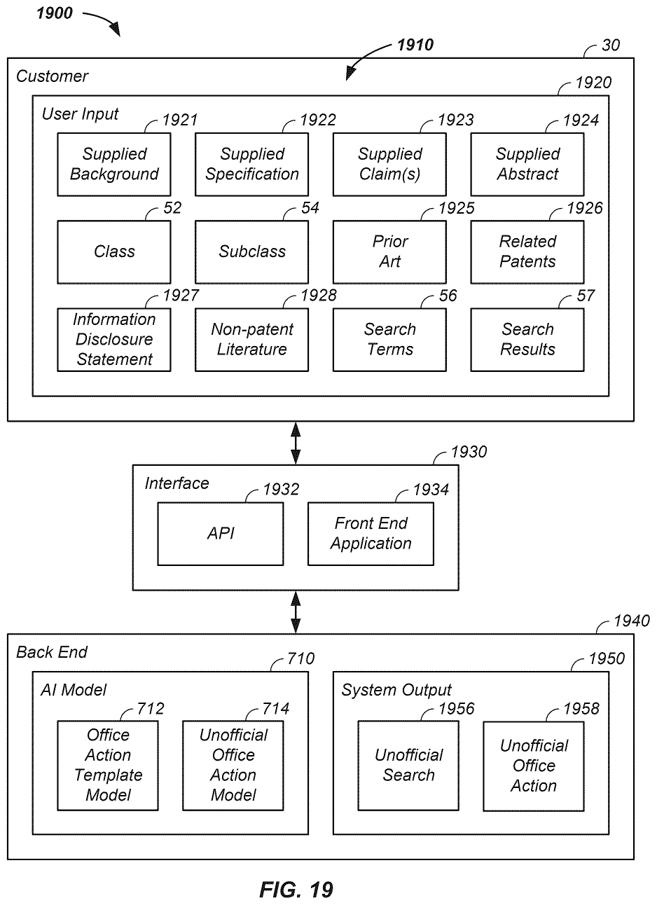

Referring now to FIG. 19 a user interface system 1900 is illustrated. Generally, a customer 30, such as a patent agent 20, a patent attorney, a company, a firm, and/or an individual, optionally interacts with a back-end 1940, such as containing the artificial intelligence model 710, through an interface 1930, such as an application programming interface 1932 (API) and/or a front end application 1934. As illustrated in this example, the customer 30 provides elements of patent prosecution 1910, such as user input via a user interface 1930. Examples of user input 1920, such as via a user interface, includes any element of a patent application/disclosure, such as a supplied background 1921/background section; a supplied specification 1922, such as a specification text; supplied claims 1923, such as in keyword, simple sentence, and/or claim format as described supra; a supplied abstract 1924, such as text description of the invention limited to 150 words; a class 52; a subclass 54; prior art 1925; related patents 1926, such as those from the customers 30 background/company; an information disclosure statement 1927; non-patent literature 1928; search terms 56; and/or search results 57, such as from prior searches. Generally, a programmer using the API 1932 and/or a user using the front end application 1924 provides the user input 1920 to a back end 1940, such as incorporating any system described herein, such as the artificial intelligence model 710. Output/system output 1950, such as from the artificial intelligence model 710, is then provided back to the customer 30, such as through the interface 1930, a file transfer protocol, an email, or even a physical delivery, such as through the mail. Optionally and preferably, the interface 1930 collects fees from the customer for use of any element of the model assisted patent prosecution system 100 and/or the artificial intelligence model 701 therein. Optionally, the back end 1940 is in the cloud, in an online application, and/or in an application, such as user downloaded, on a local client, such as a computer under the control of the customer. For example, a first fee is collected for a search, a second fee is collected for reviewing a patent application, a third fee is collected for reviewing an independent claim, and/or a fourth fee is collected for reviewing a dependent claim, where the review is optionally in any format, such as a pass/fail, a search result, an amendment to the claim/specification, a suggested new claim/specification element, and/or a returned unofficial office action.

Still referring to FIG. 19, in one example the artificial intelligence model 710 includes an office action template model 712, which provides/generates a form of an office action and/or an unofficial office action model 714, such as used to fill out details of an office action template. Optionally, the office action template model 712 is created with input from greater than 100, 1000, 10,000, 1,000,000, or 10,000,000 file wrappers, which provides a substantial database for the artificial intelligence model to determine a form of an office action, and/or the office action template model 712 is simply a provided office action template for the artificial intelligence model 710 to fill out, such as generated with traditional code. In one case, the unofficial office action model 714 is trained with the same input as the office action template model 712. In a second case, the unofficial office action model 714 is trained, at least partially, in a manner not used in training the office action template model 712. For instance, in a case where 1,000,000 plus file wrappers are used to train the office action template model 712, training of the unofficial office action model 714 is optionally more focused on relevant technical subject matter. For instance, the unofficial office action model 714 is optionally trained with file wrappers/patents related to the user suggested invention, such as the class 52, related classes, technically related classes, the subclass 54, the prior art 1925, newly found art, and/or search results. In the later case, the idea is that massive data is optionally used to train a template whereas more focused data is optionally used to train the unofficial office action model 714, which can lead to more accurate, precise, and/or focused results. Optionally, any element of the model assisted patent prosecution system 100, the artificial intelligence model, and/or the unofficial office action model 714 is trained with any amount of data, such as a wide range of file wrappers/prior art 1925 or a narrow range of focused prior art, search results 57, and/or information found in the class 52/subclass 54.

Still referring to FIG. 19 and referring again to FIG. 5, optionally any element of the office action generation system 500 and/or the unofficial office action generator 510 is used in generation of/use of the office action template model 712 and/or the unofficial office action model 714 and vice versa.

Still referring to FIG. 19, the system output 1950, such as supplied back to the customer 30/user, includes an unofficial search 1952. An unofficial search system 2000 is further described infra.

### Unofficial Search

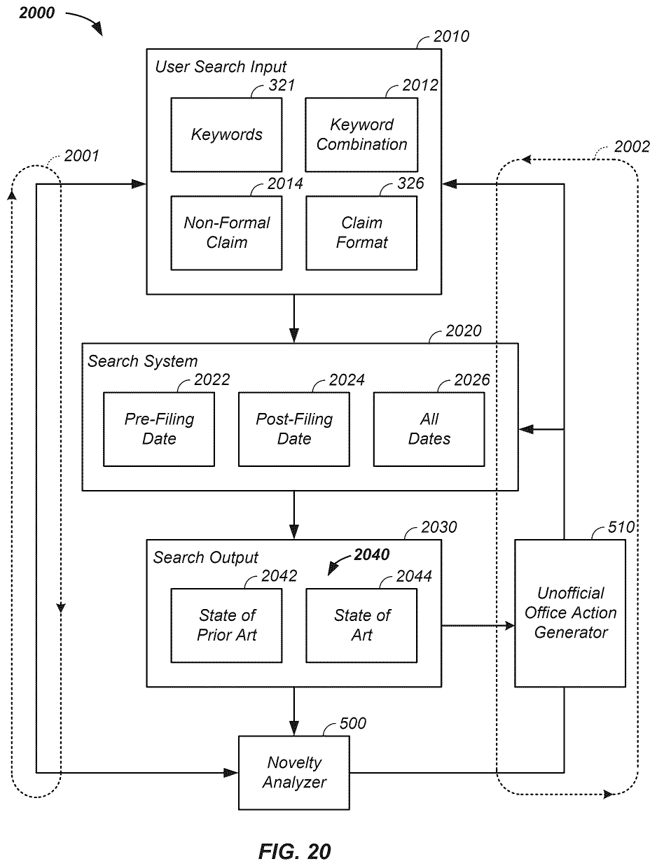

Referring now to FIG. 20, an unofficial search system 2000 is illustrated, where any element thereof is optionally used by a patent examiner/government system in generation of an official search.

Still referring to FIG. 20 and referring again to FIG. 4, generally, a user, such as a customer 30, provides a user search input 2010. The user search input 2010 optionally includes any of the elements of the user input 9120, described infra. Here, for clarity of presentation and without loss of generality, the user search input 2010 includes keywords 2012; keyword combinations 2014; a non-formal claim 2016, such as in sentence format 322; a combination of elements format 324, and/or a proposed claim 2016/formal claim, such as written by a patent attorney in a claim format 326.

Still referring to FIG. 20, a search system 2020 is subsequently optionally used to assign a priority date to combinations of user search input elements. For example, a first element and a second element in a claim may have early associated dates, such as a first date and a second date, but may have a later combination date. For instance, the search system 2020 optionally takes a combination of elements, such as from the user search input 2010 and/or the user input 1920, and determines a date, such as a pre-filing date 2022, a post-filing date 2024, and/or all dates 2026. For instance, the combination of elements may have an earlier date if filed in related patents 1926 having a common inventorship and/or assignment. Search output 2030 from the search system then generates a search result 2040, such as report of a state of prior art 2042 for dates prior to a priority date, such as a pre-filing date and/or simply a state of the art 2044 report, such as relating to all art for all dates 2026. The novelty analyzer 500 then compares the inventors idea, such as based on a combination of keywords 2014 and/or a proposed claim 2016 having a priority date against the state of the prior art 2042 in determination of a likelihood of patentability, such as with the unofficial office action generator 510. In an optional claim search 2001, which is optionally iterative, user input 1920 is tested/modified in attempts to have output from the novelty analyzer 500 indicate a likelihood of patentability, such as with use of the novelty analyzer 1410, described supra. In an optional office action assessed search 2002, which is optionally iterative, the unofficial office action generator 510, yields output that aids in understanding which elements from the user input 1920 result in a greater likelihood of claim allowance. Generally, the search system 2020 optionally and preferably searches any database, such as a government database, any published work, and/or any documents provided by the user/customer 30, such as in the user input 1920, in an information disclosure statement 1927, in non-patent literature 1928, and/or in the user search input 2010.

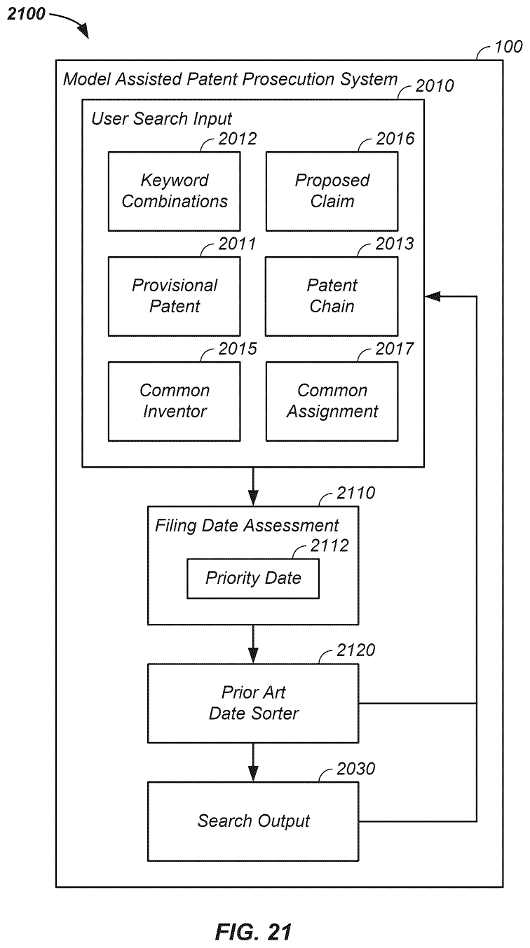

Still referring to FIG. 20 and referring now to FIG. 21, priority dates are further described in a priority date assessment system 2100. Generally, in the model assisted patent prosecution system 100, the user search input 2010 optionally and preferably includes information from a related provisional patent 2011; a patent chain 2013, such as any of continuation/continuation-in-part/divisional related patents; information on a common inventor 2015; and/or information on a common assignment 2017/common owner, such as related to an invention as described supra, such as in terms of a keyword combination 2012 and/or a proposed claim 2016. A filing date assessment module 2110 then determines a priority date 2112, for the proposed claim 2016. A prior art date sorter 2120 then selects as potential prior art any search result with a prior art date prior to the priority date 2112. The search output 2030 is, in this case, limited to articles/literature/published documents/patent applications/publications having published dates/prior art dates prior to the priority date 2112.

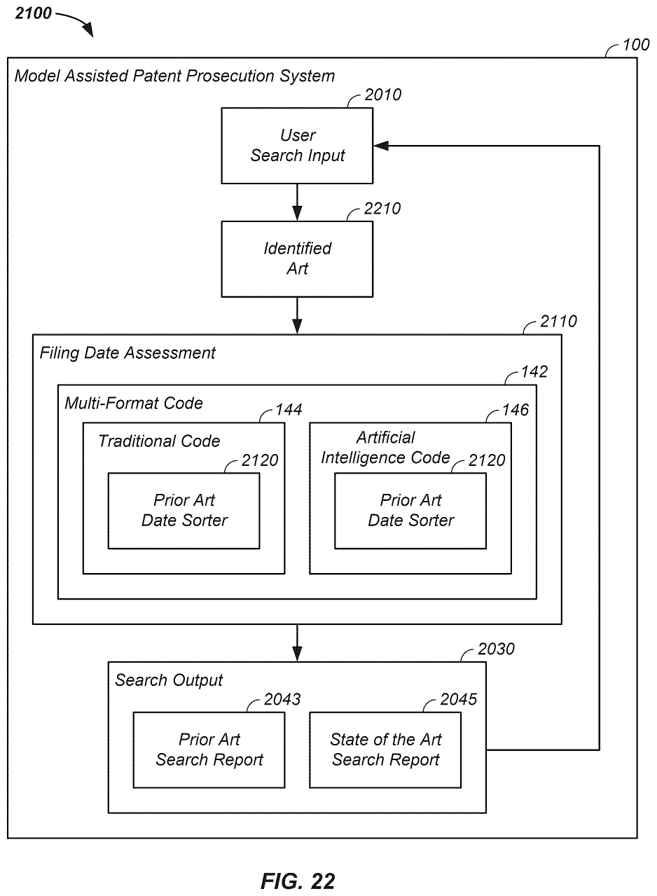

Referring now to FIG. 22, the priority date assessment system 2100 is further described. As above, user search input 2010 is used to identify a potential novel claim, such as in terms of a keyword combination 2012 and/or a proposed claim 2016. Again, identified art 2210 is assessed in terms of a filing date assessment 2110. Here, multi-format code 142, which is an example of a blended code system 140, uses traditional code 144 and/or artificial intelligence code 146 in the prior art date sorter 2120. Prior art 1925, having dates prior to the priority date 2112, is then reported in a prior art search report 2043 and/or is assessed against the proposed claim 2016, such as with the unofficial office action generator 510. A filing date, filter, common owner/assignee, and/or a common inventor filter is optionally use, such as in the front end/application programming interface (API). Optionally, a state of the related art search report 2045 is generated, such as with part/all of the related art/identified art 2210, such as having a post-filing date 2024, a post priority date 2024, or indeed all dates 2026.

### Office Action

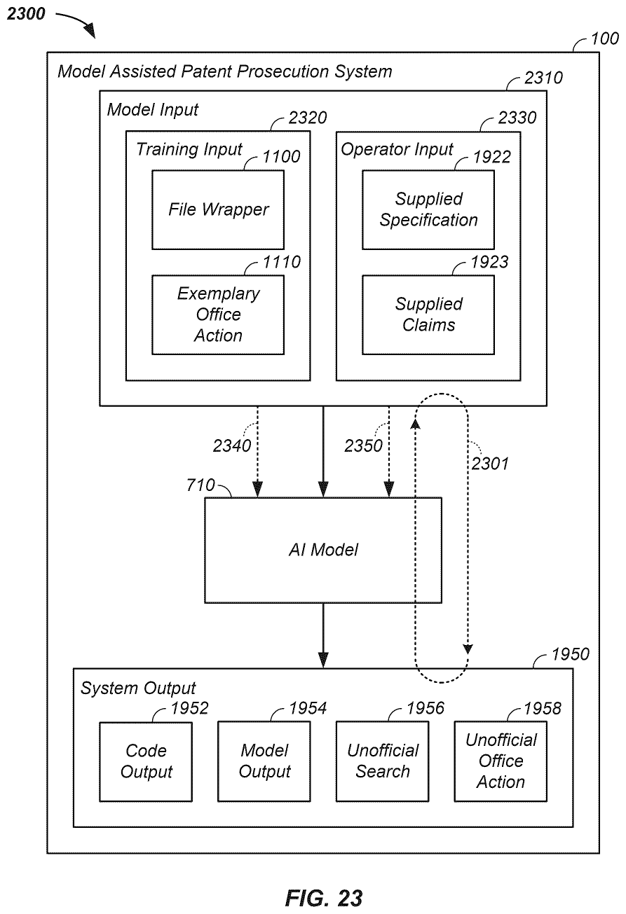

Referring now to FIGS. 23-30, the unofficial office action 2510, such as generated with the office action generation system 500 and/or the unofficial office action generator 510 is further described. The unofficial office action 2510 is optionally an official office action when generated by, partially generated by, and/or approved/used by a patent office examiner/official.

Referring now to FIG. 23, model training and/or use 2300 is further described. Generally, in the model assisted patent prosecution system 100, model input 2310 is provided, such as with a training input 2320 and/or with an operator input 2330. Generally, model training 2340 of the model/artificial intelligence model 710 occurs first and subsequently the model/artificial intelligence model 710 is used in a model use 2350 step, but model use 2350 is optionally used to concurrently train the model. While the artificial intelligence model 710, for clarity of presentation and without loss of generality, is used to illustrate aspects of the model assisted patent prosecution system 100, any model is optionally used, such as a probability model.

Still referring to FIG. 23, the training input 2320 is illustrated as being provided input from the file wrapper 1100 and/or an exemplary office action 1110 to the artificial intelligence model. However, the training input optionally and preferably uses any element of patent prosecution and/or any of the elements of the user input 1920, described supra. For example, the artificial intelligence model 710 is optionally trained with any material from any patent class 52/subclass 54; any prior art 1925; any related patents 1926; any information from an information disclosure statement 1927; any drawing/patent drawing; any information from non-patent literature; any published work; any element of search systems/search libraries; and/or any element provided in and/or linked to in a file wrapper 1100.

Still referring to FIG. 23, during model use 2350, the patent agent 20, customer 30, and/or more generally the user 10 provides an operator input 2330 to the artificial intelligence model 710. While the operator input is 2330 is illustrated as a supplied specification 1922 and/or supplied claims 1923, the operator input 2330 optionally includes any of the above described user inputs 1920.

Still referring to FIG. 23, the artificial intelligence model 710/model provides a system output 1950, such as code output 1952, model output 1954, an unofficial search 1956, and/or an unofficial office action 1958. An example of code output 1952 is a response to an application programming interface (API) and/or user interface query. Optionally and preferably, the model use is iterative 2301, such as a user providing a set of desired claims, the model providing a related search/office action back to the user, and the user trying new claims until satisfactory search/office action results are obtained, such as prior to filing a related official patent application.

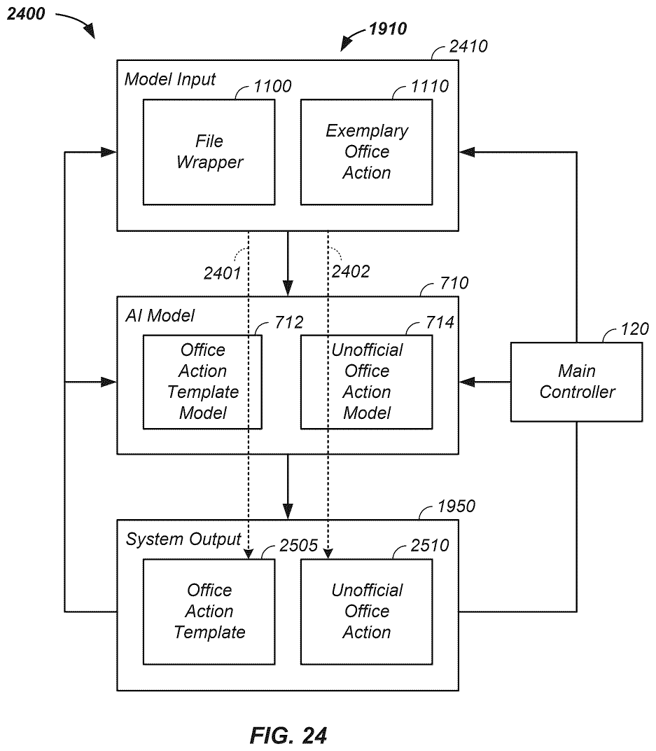

Referring now to FIG. 24, an artificial intelligence patent training system 2400 is illustrated. Generally, model input(s) 2410 are provided to the artificial intelligence model 710 and the artificial intelligence model generates a system output 1950, where the process is optionally and preferably iterative. Each step if further described here.

### Example I

Still referring to FIG. 24, the model input 2410 optionally uses any published and/or non-published information. In this example, provided for clarity of presentation and without loss of generality, elements of patent prosecution 1910 are used as model inputs 2410. For example, elements of a file wrapper 1100 and/or elements of an exemplary office action 1110 are used as model inputs 2410.

### Example II

Still referring to FIG. 24, in a first process 2401, such as in a first model, a large number of exemplary office actions 1110, such as from corresponding file wrappers 1100 are fed into the artificial intelligence model 710 and/or an office action template model 712, where the artificial intelligence model 710 and/or the office action template model 712 is used to generate an office action template 2505. The idea is that office actions have many common features, where the common features each contain what amounts to fillable fields. Thus, greater than 100, 1000, 10,000, 100,000, 1,000,000, or 10,000,000 office actions 1110 from government file wrappers 1100 are optionally used to train the neural network 730 to form an office action template 2505. Optionally, a fillable office action template 2505 is simply provided to the artificial intelligence model 710.

### Example III

Still referring to FIG. 24, in a second process 2402, the office action template 2505 is filled in by the artificial intelligence model 710. In one case, the first model generated in the previous example is used to fill in the office action template 2505, such as where the artificial intelligence model 710 trained with subject matter from greater than 10, 50, or 100 classes. In a second case, a second model is generated with information that is more closely associated with a given patent application, a given set of claims, and/or a given invention. For instance, if a user 10 provides a claim to the artificial intelligence model 710 and desires an unofficial office action 2510 to assess potential novelty of the claim, then a model more tightly defined about the claim is optionally used. For instance, if a first class is associated with the provided claim, then in the second process 2402 elements from the first class and/or associated linked classes are used as model inputs 2410 to train a more narrow and thus more accurate model. For instance, the second model is trained with subject matter from less than 50, 20, 10, 9, 8, 7, 6, 5, 4, 3, or 2 classes and/or from less than 50, 20, 10, 9, 8, 7, 6, 5, 4, 3, or 2 class-subclass combinations. Similarly, the second model is trained with data, information, drawings, and/or text from associated patents/non-patent literature, such as provided in an information disclosure statement 1927, in a prior art search, and/or an application data sheet.

Comparing the above provided examples, in one optional process the office action template 2505 is built with massive amounts of data, such as from millions of training examples, such as from a majority and/or all classes. Further, in another optional process, the unofficial office action 2510 optionally fills in the office action template 2505 and/or the unofficial office action model 714 is trained with a limited number of classes/subclasses that are closely associated with a user provided claim set.

The office action template 2505 and/or sections of the unofficial office action 2510 are further described here.

### Office Action Elements

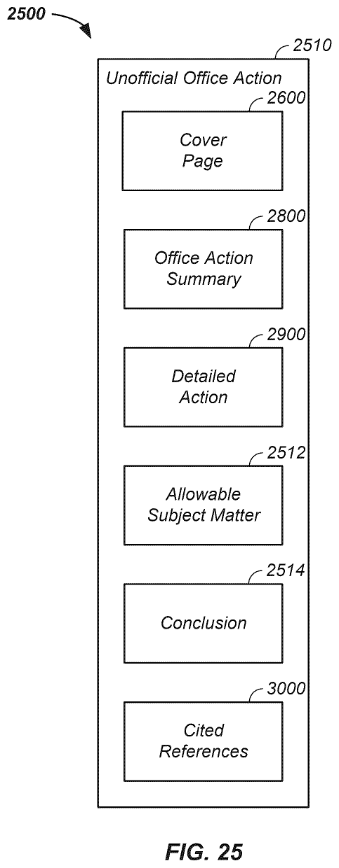

Referring now to FIGS. 25-30, optionally and preferable elements of an office action 2500 are described.

### Example I

Referring now to FIG. 25, optionally and preferably the unofficial office action 2510 includes one or more of: a cover page 2600, an office action summary 2800, a section to a detail action 2900/detailed actions, allowable subject matter 2512, allowed claims, a conclusion 2514, and/or cited references 3000. Each of these sections are further described, infra.

An unofficial office action optionally becomes an official office action when prepared/sent, directly and/or indirectly, to an applicant by a government patent examiner.

### Example II

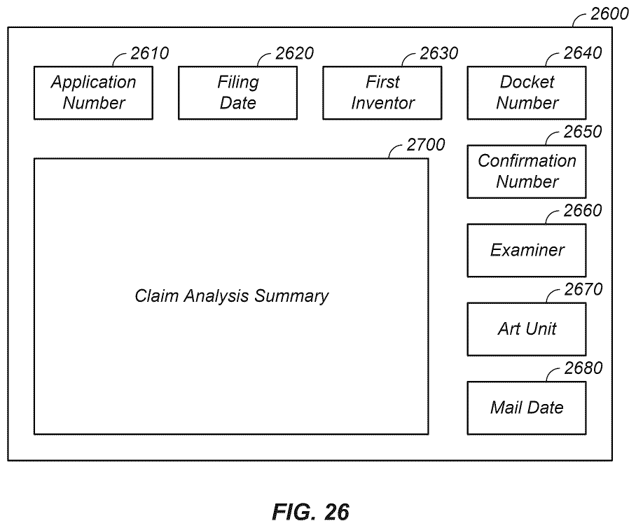

Referring now to FIG. 26, an example of the cover page 2600 is provided for clarity of presentation and without loss of generality. The cover page 2600 optionally and preferably includes, in any layout, one or more of: an application number 2610, a filing date 2620, an identification of a first inventor 2630, a docket number 2640, a confirmation number 2650, an identification of an examiner 2660, an art unit 2670, a mail date, a class 52, a subclass 54, and/or a claim analysis summary 2700. Naturally, in an unofficial office action 2510 many of the elements are not known, but when used in an official context, the elements are known and are preferably filled in/auto filled in by the model.

### Example III

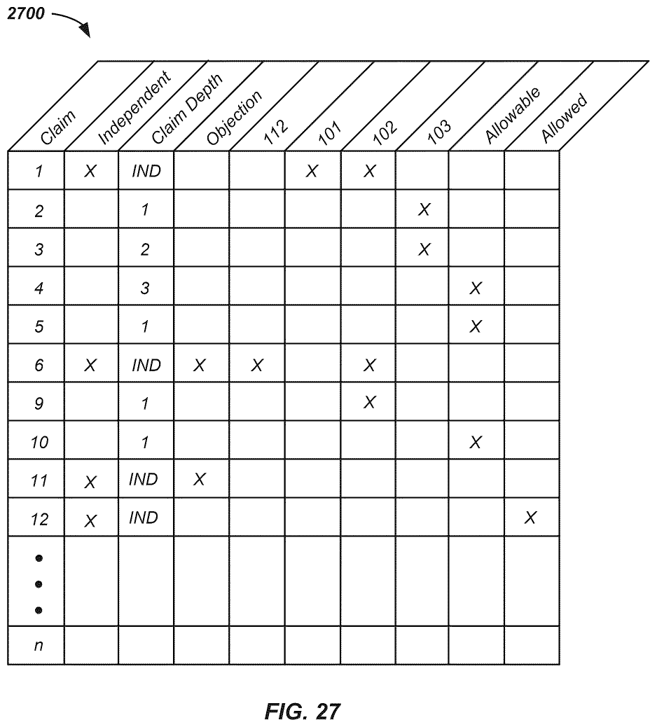

Referring now to FIG. 27, an example of the claim analysis summary 2700 is provided. Generally, in traditionally provided office actions, such as provided by the U.S. Patent and Trademark Office, claims are only summarized as pending, objected, rejected, and/or allowed. For a patent attorney/agent, a much more helpful claim analysis summary 2700 includes claim depth and/or reasons for objection/rejection. In the provided example of a claim analysis summary 2700 considerably more information is immediately conveyed to the patent attorney/agent. For instance, the second column immediately conveys which claims are independent. Further, the third column immediately conveys a claim depth. For instance, a first child claim directly dependent from an independent claim is conveyed with a first claim depth, such as “1”. A second child of the first child has a second claim depth, such as “2” and a third child of the second child has a third claim depth, such as “3”. The designated 1, 2, 3 claim depths are alternatively labeled as 2, 3, 4 if the independent claim has a first depth. Thus, the third column immediately conveys to the patent attorney/agent which claims are likely to be more narrow. For instance, the third and fourth claims are more narrow than the second claim. The fourth column identifies which claims are currently objected to. Thus, a glance at the claim analysis summary 2700 indicates the that third independent claim, claim 11, is only objected to, which provides the patent attorney/agent an immediate starting point in terms of getting a claim allowed. The fifth, sixth, seventh, and eighth columns identify any article 35 U.S.C. § 112 rejection, any article 35 U.S.C. § 101 rejection, any article 35 U.S.C. § 102 rejection, and any article 35 U.S.C. § 103 rejection, respectively. The ninth and tenth columns identify allowable and allowed claims, respectively. Thus, in this example, the patent attorney/agent is made immediate aware that:
claim 12 is allowed, which might cause the patent attorney/agent to cut costs and merely take this claim;
claim 11 merely has an objection, which the patent attorney/agent knows is often trivial and should be looked at;
claim 10, a first depth claim, is allowable, which is often indicative of merely a need to rewrite the claim into independent claim format to get the claim allowed;
claim 9, another first depth claim, faces a more difficult 102 rejection;
Claim 5 is likely better than claim 4 as both are allowable, but claim 6 is two depths shallower; and
claim 1 faces a 102 rejection that often calls for a claim amendment, claims 2 and 3 are indicators of failed more detailed claims, while claims 4 and 5 are good indicators of claim amendments leading to allowance.

While FIG. 27 is merely illustrative, it demonstrates considerable conveyance of information to the patent attorney/agent, such as without yet having even looked at the claims. The claim analysis summary 2700 is optionally quantified, such as to yield a probability of claim allowance. For instance, if a claim is given ten 102 rejections, the probability of claim allowance approaches zero, whereas another claim facing only objections approaches a one hundred percent chance of claim allowance. Similarly, more elements of cited prior art, such as greater than 2, 4, 6, 8, or 10 elements in a given 103 rejection indicate progressively higher chances of allowance. This is all optionally built into a claim allowance model and/or quantified, in the binary analyzer 1412 and/or the probability analyzer 1414. Similarly, the claim analysis summary 2700 optionally and preferably functions as a guide to the amended idea generator 1322, such as for use in an artificial intelligence generated claim 1330, such as in the sixth process 666 and/or the seventh process 777 of iteratively testing claim ideas for novelty.

Generally, the model optionally assigns a probability to an allowance of a claim. For each 35 U.S.C. § 102 rejection the probability decreases dramatically from 100 percent toward zero percent. For each 35 U.S.C. § 103 rejection, the probability decreases at a rate lower than a 35 U.S.C. § 102 rejection. For each 35 U.S.C. § 112 rejection, the probability decreases at a rate lower than a 35 U.S.C. § 103 rejection. For clarity of presentation and without loss of generality, an exemplary probability of allowance, as a percentage, is given by equation 1,

$$Probability = 100 - {C}_{1} * m ( 102 ) - {C}_{2} * n ( 103 ) - C 3 * o ( 101 ) \qquad ( eq . 1 )$$

where m is the number of −C₁*m (102)−C₂ rejections, n is the number of 35 U.S.C. § 103 rejections, o is the number of 35 U.S.C. § 101 rejections, C₁ is a first constant, such as 25, and C₂ is a second constant, such a 5, and −C₃ is a third constant, such as 1. For instance, a claim rejected by the model with three separate 102 rejections, two 101 rejections, and a 101 rejection has a probability of allowance of 100-3(25)−2(5)−1(1) or 14%. Any equation linking probability, in any unit, to rejections under any one or more of 35 U.S.C. § 101, 35 U.S.C. § 102, 35 U.S.C. § 103, and/or 35 U.S.C. § 112, with any set of constants or no constants, is optionally used as a probability assessment of likelihood of allowance/allowability of the claim presented to the model, such as where the model identifies the likely rejects of the claims under any section of 35 U.S.C.

### Example IV

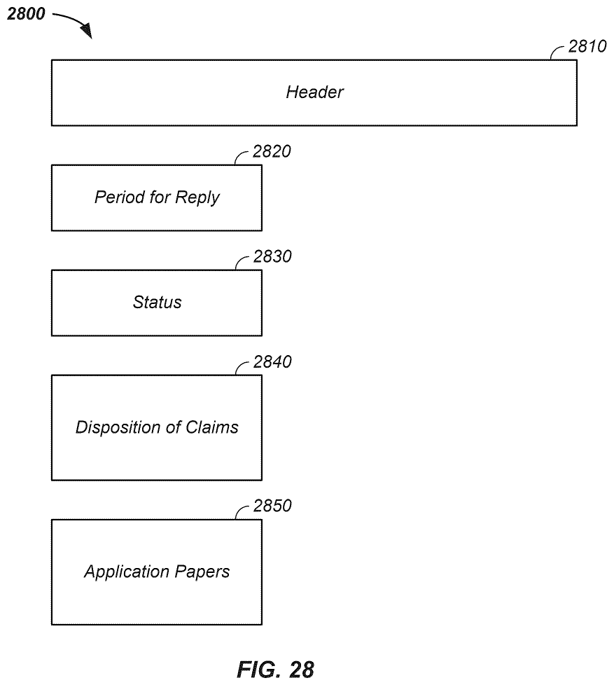

Referring now to FIG. 28, an example of the office action summary 2800 is provided for clarity of presentation and without loss of generality. In this example, the office action summary 2800 optionally includes one or more of: a header 2810, a period for reply 2820, a status 2830, a disposition of claims 2840, and/or application papers 2850. This example, like the others, are optionally examples of sections of the office action template 2505 that are filled in in the unofficial office action 2510.

### Example V

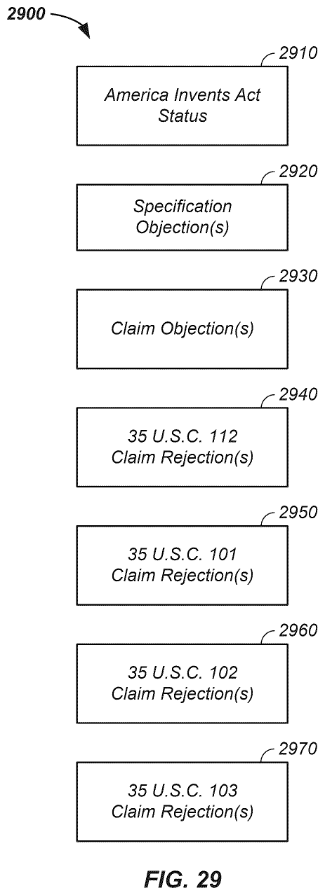

Referring now to FIG. 29, an example of the detailed action 2900 is provided for clarity of presentation and without loss of generality. In this example, the detailed action 2900 optionally includes one or more of:
an America Invents Act status 2910;
specification objection(s) 2920 to the specification 1652;
claim objection(s) 2930;
35 U.S.C. § 112 claim rejection(s) 2940;
35 U.S.C. § 101 rejection(s) 2950;
35 U.S.C. § 102 rejection(s) 2960;
35 U.S.C. § 103 rejection(s) 2970;
double patenting rejections(s); and/or
a quote from the Manual of Patent Examining Procedure (MPEP).

Again, these are sections that are optionally in a template where the template is filled in and/or are simply sections generating in the output.

### Example VI

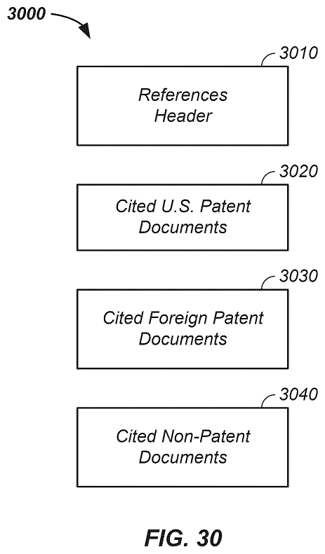

Referring now to FIG. 30, an example of the notice of cited references 3000 is provided for clarity of presentation and without loss of generality. In this example, the notice of cited references 3000 optionally includes one or more of: a references header 2810, cited U.S. patent documents 3020, cited foreign patent documents 3030, and/or cited non-patent documents/non-patent literature.

### Metadata

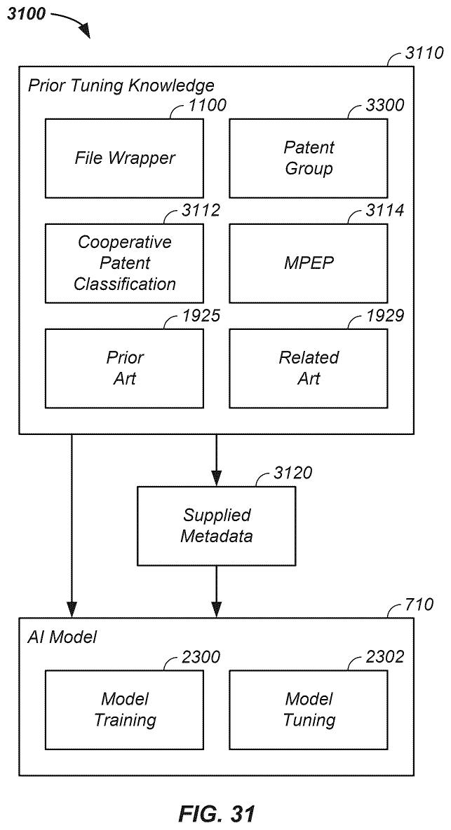

Referring now to FIGS. 31-38, prior knowledge is used to derive metadata for training of the artificial intelligence system model 710. More particularly, metadata is optionally and preferably included in/with datasets, text, figures, and/or any training input provided to the input layer 610 of the neural network 600 of the artificial intelligence model 710.

Generally, metadata is any text/simple text that is readily interpreted by both humans and computers. An example of metadata is that from a JavaScript Object Notation, which is a lightweight, human-readable data interchange format used to store and transmit data as key-value pairs and arrays. Here, a key-value pair is a data structure that pairs a unique key with a corresponding value and/or file. The key acts as an identifier, like a label, that you use to look up or access its associated value, which is the actual data/actual file. The key-value pair is a fundamental structure often that is optionally used to describe metadata, where metadata, by definition, is “data about data.” It provides descriptive information about a resource, such as a file, object, or piece of content. For instance, if a specification and a set of claims are uploaded to the artificial intelligence model, then the metadata is optionally “specification” and “claims”, respectively.

For clarity of presentation and without loss of generality, several examples of metadata are provided in this section.

Referring now to FIG. 31, prior knowledge incorporation 3100 to the artificial intelligence model 710, such as a patent prosecution model, is illustrated. Generally, prior tuning knowledge 3110 is optionally and preferably supplied/coupled with inputs, such as documents, text, illustrations, figures, and/or art, to the artificial intelligence model 710, such as in the form of supplied metadata 3120. For clarity of presentation and without loss of generality, sources of prior tuning knowledge 3110, such as for a patent prosecution tuned model, include: a file wrapper 1100, information within a patent group 3300, information within a common and/or closely linked class in the cooperative patent classification (CPC) 3112 system, information within the manual of patent examining procedure 3114 (MPEP), information in/about prior art 1925, and/or information in/about related art 1929. For instance, the file wrapper 1100 includes information about individual steps in patent prosecution and/or links therebetween; the patent group 3300 contains information about related patent family elements, such as continuations, divisionals, and/or continuations-in-part; the cooperative patent classification 3112 links to related applications/information based on patent class, which historically is patent class/patent subclass; the manual of patent examining procedure 3114 includes rules/guidelines for patent examination/patent response; prior art 1925 contains information about a claim published prior to a prior art date; and related art 1929 contains information related to a claim published at any time. Prior tuning knowledge 3110 is further described infra. Again, supplied metadata 3120 related to any element of the prior tuning knowledge, such as text and/or drawings of elements therein are supplied to the artificial intelligence model 710 along with supplied metadata 3120, such as of model training 2300 and/or model tuning 2302. For example, a set of claims are supplied as text to the artificial intelligence model 710 along with metadata, such as the word “Claims”, text related to a patent application number, a date, and/or a source or outcome, referred to herein as a prior and a posterior/post, respectively.

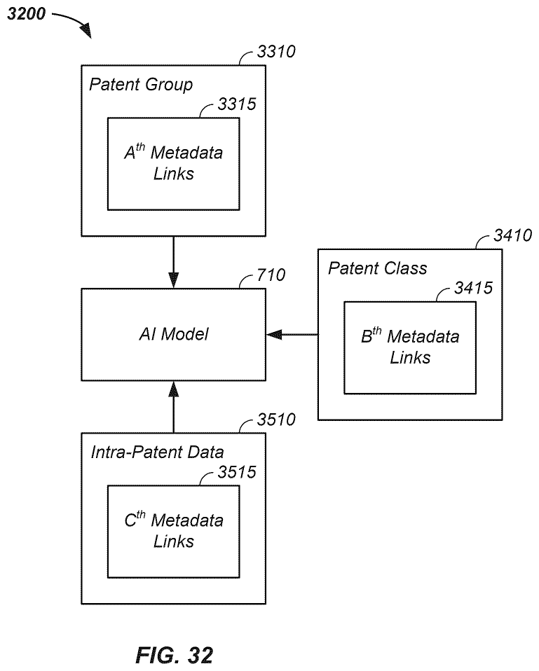

Referring now to FIG. 32, exemplary metadata sources 3200 to the artificial intelligence model 710 are illustrated. In FIG. 32, supplied metadata 3120 is broken into three types, where supplied metadata 3120 is optionally classified in any manner. In the exemplary classification illustrated in FIG. 32, information from within the patent group 3310 is described with A^{th} metadata links 3315; information from within a common patent class 3410 and/or a linked patent class 3410 is described with B^{th} metadata links 3415; and intra-patent data 3510 intra-patent information, such as within and/or between patent sections, is described with C^{th} metadata links. The metadata linked to the patent group 3310, the patent class 3410, and the intra-patent data 3510 is further described, infra.

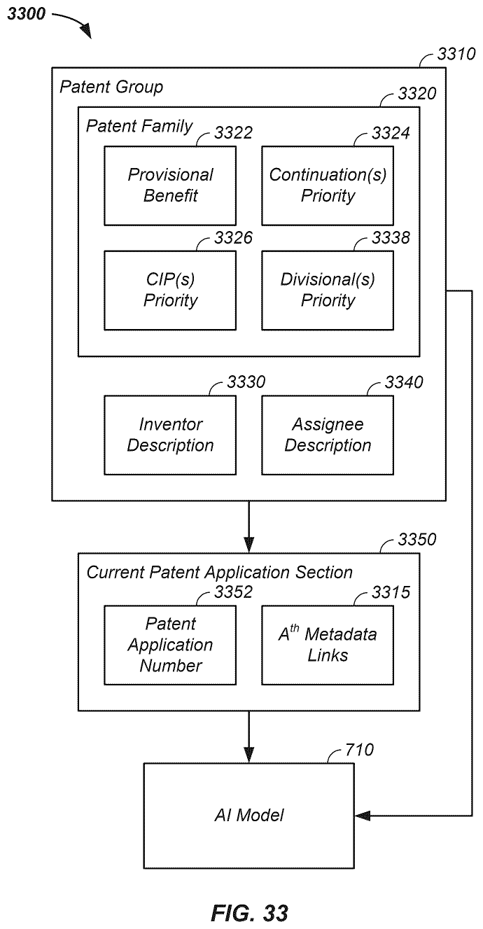

Referring now to FIG. 33, the patent group 3310 and the A^{th} metadata links 3315 associated with information within the patent group 3310 is further described in a patent group classification/metadata link system 3300. Generally, a patent group 3310 includes a patent family 3320, where a patent family includes a coupling/a link to: a provisional benefit 3320, a continuation priority 3324, a continuation-in-part (CIP) priority 3326, and/or a divisional priority 3338. For instance, the A^{th} metadata links 3315 to any portion of a patent application loaded into the artificial intelligence model 710, such as a specification, a provisional patent application filing number, a continuation patent application filing number, a continuation-in-part patent application filing number, and/or a divisional patent application filing number. Further, the patent family 3320 includes any element of the linked patents/patent applications, such as a linked title, a linked specification, a linked abstract, a linked drawing, a linked claim prosecution history, and/or any element of the linked file wrappers.

### Example I

For clarity of presentation and without loss of generality, in the above described section, A^{th} metadata links 3315 linked to the patent family 3320 optionally include any element of a parent, such as derived from JavaScript Object Notation code, such as:

```
“parentContinuityBag”: [
  {
    “parentApplicationStatusCode”: 150,
    “firstInventorToFileIndicator”: false,
    “claimParentageTypeCode”: “DIV”,
    “claimParentageTypeCodeDescriptionText”: “is a Division of”,
    “parentApplicationStatusDescriptionText”: “Patented Case”,
    “parentApplicationNumberText”: “12618718”,
    “parentApplicationFilingDate”: “2009-11-14”,
    “childApplicationNumberText”: “13481923”,
    “parentPatentNumber”: “8178859”
  },
```

For instance, metadata linked to any element of the parent patent application is provided with any element of the current patent application or child application number, such as: a parent patent number; a parent type, such a continuation of, a divisional of, or a continuation-in-part of; a parent application number. The metadata, which provides prior information to the model, aids in accuracy, precision, and/or efficient tuning of the artificial intelligence model 710.

Still referring to FIG. 33, the patent group 3310 optionally includes an inventor description 3330, such as a common inventor, and/or an assignee description 3340, such as a common assignee.

### Example II

For clarity of presentation and without loss of generality, in the above described section, A^{th} metadata links 3315 linked to the assignee 3340 optionally include any element of a second output from a JavaScript Object Notation code, such as:

```
“assigneeBag”: [
  {
    “assigneeAddress”: {
      “cityName”: “NOVOSIBIRSK”,
      “geographicRegionCode”: “RUX”,
      “postalCode”: “63039”,
      “addressLineOneText”: “KRASKAYA STREET”,
      “addressLineTwoText”: “187A”
        },
    “assigneeNameText”: “BALAKIN, VLADIMIR”
  },
```

For instance, the artificial intelligence model 710 is provided with prior knowledge, such as metadata linked to the current patent application, such as an assignee name, such as in text reading: “assigneeNameText: BALAKIN, VLADIMIR”, “Vladimir”, “Balakin”; a key value pair; a field name and/or an associated field value/field value; and/or a reference to an inventor, which provides prior information to the model that aids in accuracy, precision, and/or efficient tuning of the artificial intelligence model 710.

Optionally and preferably, metadata in a format of a key value pair is used to submit metadata to the artificial intelligence model 710, such as when coupled to a submitted document, such as text, a figure, and/or any section of a patent application/office action/response and/or a section of a given file wrapper.

Referring to FIGS. 33-35, optionally any section of any patent, patent application, file wrapper, prior art, and/or art is fed directly into the artificial model 710 with/without associated metadata.

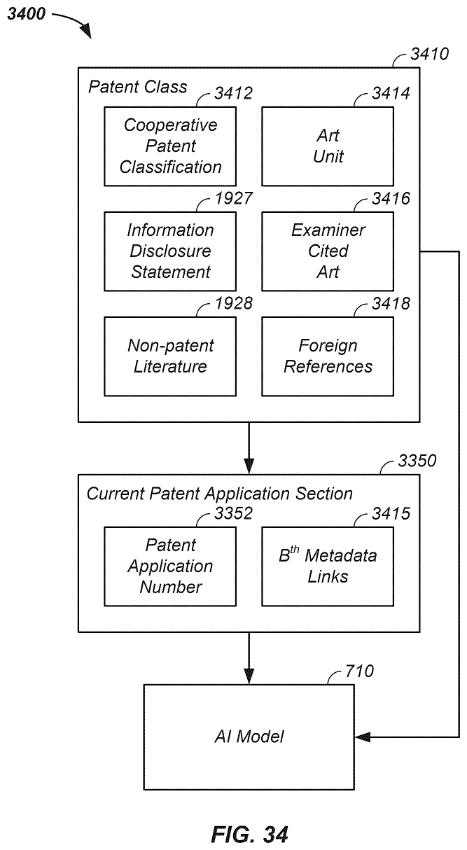

Referring now to FIG. 34, the patent class 3410 and the B^{th} metadata links 3415 associated with information within the patent class 3410 is further described in a patent class classification/metadata link system 3400. The patent class 3410 is optionally and preferably, for a given patent, any related patent/patent application in/assigned to: a section of the cooperative patent classification 3412; an art unit 3414; in an information disclosure statement 1927; examiner cited art 3416; non-patent literature 1928; and/or foreign references 3418, each of which are described further herein.

In a first example, the patent class 3410 optionally includes any patent/patent application number in the same cooperative patent classification (CPC) group/class/subclass as the current patent application. For instance, if the current patent application is identified as being in subclass G01G of the CPC, to weighing, then other patents/patent applications in subclass G01G are in the same patent class 3410 as the current patent application. Thus, keywords identifying subclass G01G and/or any element thereof are optionally used as metadata associated with any element of the current patent/patent application when fed into the artificial intelligence model 710, such as a current title, specification, claim set, abstract, and/or drawing. Metadata related to linked classes is optionally also supplied as metadata, such as to classes identified by an patent examiner in a related prior art search. Similarly, any patent, patent application, and/or art element identified in the information disclosure statement 1927, examiner cited art 3416, non-patent literature 1928, and/or foreign references 3418 is optionally and preferably used as B^{th} metadata links 3415, such as with a current patent application number 3352, and is optionally and preferably linked with a current patent application section 3350, such as a title, specification, claims, abstract, and/or drawing when fed into the artificial intelligence model 710. Notably, any previously used patent class/patent subclass is optionally linked with any class currently used in the cooperative patent classification 3412. More particularly, the CPC 3412 is the modern, global classification system developed by the EPO and USPTO, while “patent class subclass” can refer to the older USPC system or the CPC system's level of classification. Herein, for clarity of presentation, the CPC system is used; however, alternative systems are readily uses, such as the International Patent Classification (IPC) and/or any hierarchical knowledge storage/reference system.

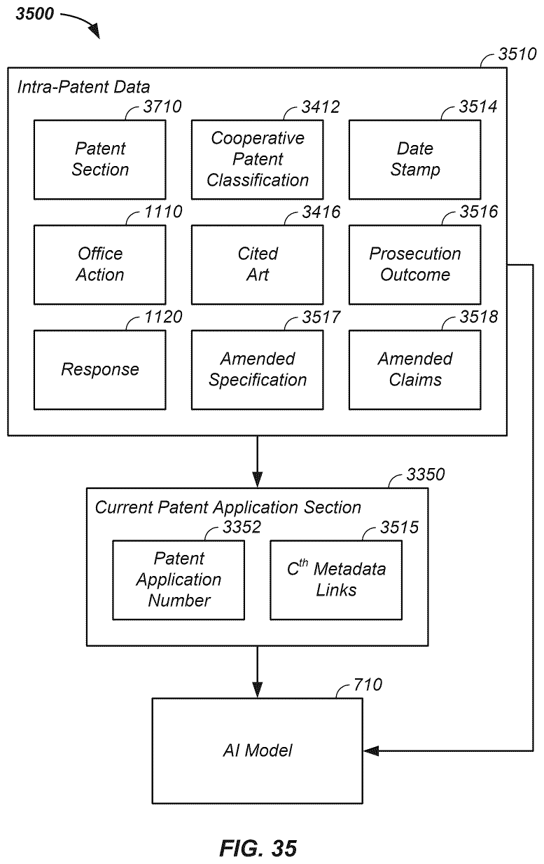

Referring now to FIG. 35, intra-patent data 3510 and the C^{th} metadata links 3515 associated with information in the intra-patent data 3510 is further described in an intra-patent data patent classification/metadata link system 3500. Herein, a patent section 3710 includes any one or more of: a title, a specification, a claim/set of claims, an abstract, a drawing, and/or any section/element of the associated file wrapper. Generally, intra-patent data 3510, in the intra-patent data patent classification/metadata link system 3500, includes any of: a patent section 3710, a cooperative patent classification 3412, a date stamp 3514, an office action 1110, cited art 3416, a prosecution outcome 3516, a response 1120, an amended specification 3517, an amended claim 3518, a patent application number 3352, and/or any element/link/section of the associated file wrapper. Generally, any element/word/outcome/label in the intra-patent data 3510 is optionally used as the C^{th} metadata links 3515 associated with any element of the patent prosecution section 3510 submitted to the artificial intelligence model 710, such as for any current patent application section 3350. Optionally and preferably, any number of current patent applications are fed into the artificial intelligence model 710, such as greater than 1, 10, 100, 1000, 10,000, 100,000, 1,000,000, or 10,000,000 patent prosecution sections, patent applications, patent file wrappers, and/or patents.

Still referring to FIG. 35, metadata to the cooperative patent classification 3412 is optionally to any one of more of: the first character, such as A, B, C, . . . ; the second and third characters, such as 01, 02, 03, . . . ; the fourth character, the last 1, 2, 3, 4 or more characters, and/or any position of the CPC classification. This allows the model results to be filtered by any of CPC section, class, sub-class (subclass), group, and/or sub-group (subgroup). Notably, as relevant art is often group in the CPC classification system to a small number of groups/subgroups and the CPC classification system is hierarchal, filtering to a higher level of the CPC classification system is optionally used to quickly limit the model search to related art/prior art in a relevant portion of the CPC system. For clarity of presentation and without loss of generality an example is provided.

### Example I

For a given CPC classification of a proposed claim, a CPC class may be determined, optionally by the model presented herein. For instance, if the claim is classified with an A23F 5/04 CPC classification, then when querying the model for related art, the query is optionally limited to CPC section A, which grabs all things in section A, is limited to class, such as class 23 or A23 (using the first three characters in this example, which grabs in the search all things in the much narrower A23 class. In this example the filter is optionally A23F 5/xx, to search all groups in the A23F part of the CPC classification. Searching narrower sections of the CPC classification system, such as through use of corresponding metadata tags, such as in specifications, abstracts, and/or drawings in a corresponding datastore, reduces search latency and reduces costs through reduction of CPU cycles used. Further, the metadata filer and/or CPC designation filter minimized/eliminates hallucinations from the model, as further described infra.

Still referring to FIG. 35, optionally and preferably patent sections/sections of the file wrapper, such as in the intra-patent data 3510, are linked together, such as with the supplied metadata. For instance, the artificial intelligence model 710 is informed/trained/tuned with metadata that links a series of events, such as original claims being examined in an office action, output of the office action being responded to in a response/amendment, and an outcome, such as in a second office action allowing certain claims. In a particular case, a claim, such as claim 1, is tracked through the file wrapper with an input claim, a series of rejections/arguments/amendments, and an outcome, such as an allowance or abandonment, where the tracking is aided with metadata linking any two or more elements of the sequence of prosecuting claim 1, such as greater than 1, 2, 3, 4, 5, 6, or more elements of the sequence. For clarity of presentation and without loss of generality, examples are provided here that illustrate section linking with metadata.

### Example I

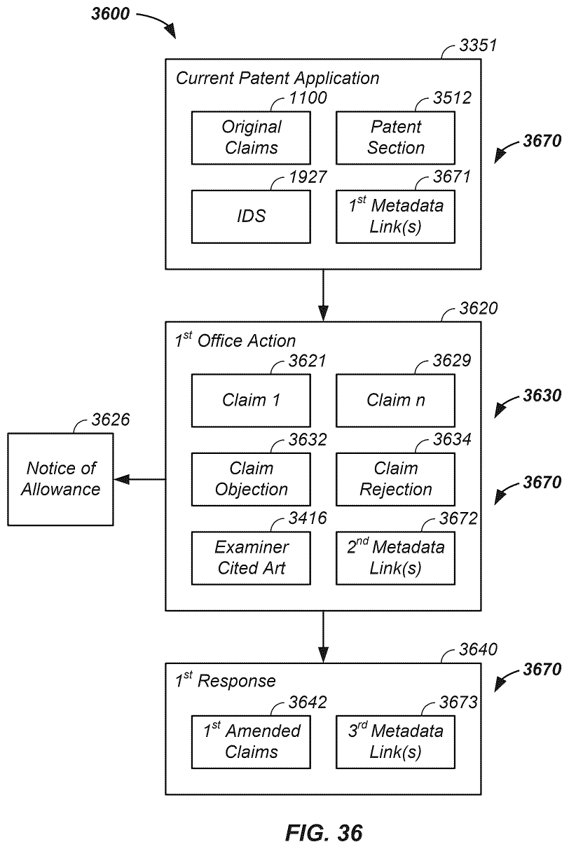

Referring now to FIG. 36, section linking examples, such as with metadata, are illustrated. Generally, any element of an office action section, such as a first office action section, is linked to a prior/previous office action section and/or to a posterior/later office action section.

### Example II

Still referring to FIG. 36, a second linking example, such as with metadata, is illustrated. Generally, any element of a current patent application 3351, such as in a given file wrapper, is linked to a first office action 3620, such as with metadata link 3670, such as a first metadata link 3671. Several cases are used to illustrate first metadata links.

In a first case, the original claims 1100 are linked to an outcome of an analysis of the claims in the first office action 3620, such as claim 1 3621 of the original claims 1100 is objected to and/or rejected under any section of article 35 and/or article 37 of the United States Code. In this case, a first metadata link 3671 links original claim 1 of the current patent application 3351 to a first outcome to claim 1 3621 in the first office action 3620. This is optionally repeated n times for claim 1 to Claim n 3629, where each claim has one or more outcomes, such as a claim objection 3632, a claim rejection 3634, and/or is analyzed using one or more art units in examiner cited art 3416, where n is a positive integer. For instance, the metadata optionally refers to words cited in a 35 U.S.C. 102/103 rejection, which keys the artificial intelligence model 710 into reasons for a claim rejection. Similarly, the metadata optionally refers to new words added to a claim in a claim amendment, which keys the artificial intelligence model 710 into reasons used to attempt to and/or to actually overcome a 35 U.S.C. 102/103 rejection. The specific first metadata links 3671 tying together elements, such as a set of claims and an office action, newly introduced words therein, and/or words in reasons citing a rejection or allowance, submitted to the artificial intelligence model 710 aids in training/tuning the artificial intelligence model 710.

In a second case, a first metadata link 3671 links any element of a patent section 3512 in the current patent application 3351 to an outcome in the first office action 3620. For instance, the patent section 3512 may be a specification with a typographical error noted by an examiner in the first office action, such as in an objection and/or in a 35 U.S.C. 112 rejection. Again, the metadata is optionally the objection/rejection type and/or a word used in the objection/rejection and/or a word/new word used in a response to the objection/rejection. Again, a specific metadata link, such as a first metadata link 3671, tying a particular element in the patent section 3512 to an outcome in the first office action 3620 aids in training/tuning the artificial intelligence model 710.

In a third case, a first metadata link 3671 links any element of an information disclosure statement 1927 in the current patent application 3351 to an outcome in the first office action 3620. For instance, an outcome of the first office action 3620 may cite an element of the information disclosure statement 1927 in an analysis of a given claim of the first office action 3621, where a link between a claim element, such as in claim 1 3621, and a page, column, paragraph, and/or line number of a given piece of art cited in the information disclosure statement 1927 are linked with a first metadata link 3671, such as word(s) in the cited section of the claim and/or in the cited section of the cited art. Again, training/tuning the artificial intelligence model 710 is aided by the first metadata link 3671 tying a particular claim element of a given claim to a particular section of a given piece of prior art.

In a fourth case, a first metadata link 3671 links a first element, word, and/or phrase of the current patent application 3351, such as a specification paragraph, page, and/or line number, to a second element of the current patent application 3351, such as a claim. For instance, telling the artificial intelligence model 710, via a linking piece metadata, that claim 1 finds support in the specification, such as at a particular section, aids in training/tuning the artificial intelligence model 710.

In a fifth case, a first metadata link 3671 links an original claim 1100 to a section, clause, and/or word(s) of a notice of allowance 3626 and/or a notice of allowability of a given claim as output in the first office action 3620. Again, the first metadata link 3671 tying together a given claim, such as claim 10 in the original claim 1100, to a reason for allowability in the first office action 3620 aids in training/tuning the artificial intelligence model 710.

In a sixth case, a metadata link, is a character reference label and or the associated word or clause, such as in the specification and/or drawings. For instance, in a particular case, presented for clarity of presentation and without loss of generality, if the specification reads: “A first magnetic coil 520”, then optional metadata includes any of a corresponding.xml reading: “A first magnetic coil <part-num-ref name=” first magnetic coil “>520</part-num-ref>”, which ties the character reference label 520 to the clause “first magnetic coil” in any one or more of the original specification, the drawings, any office action, and any response. Similarly, if the specification gives a range and/or a list of elements, then metadata helps parse the range/list to the artificial intelligence model 710. For instance, if the specification reads: “a plurality of magnets, such as 2, 3, 4, 5, 6, or more magnets” then keywords/sections of the corresponding xml file reading: “a plurality of magnets, such as 2, <part-num-ref name=” 2, “>3, </part-num-ref> <part-num-ref name=” 2, 3, “>4, </part-num-ref><part-num-ref name=” 2, 3, 4, “>5, </part-num-ref> <part-num-ref name=” 2, 3, 4, 5, “>6, </part-num-ref> or more magnets” is optionally loaded as metadata to the artificial intelligence model 710.

In a seventh case, text submitted to the artificial intelligence model, such as the specification and/or part thereof is optionally and preferably submitted to the model with or without a corresponding human/machine readable file, such as a corresponding.xml file to the specification and/or part thereof.

More generally, the metadata, also referred to as a metadata link, refers to any element of a .xml file or equivalent that parses any section of the patent application as filed into a human and machine readable format. Here, the word metadata is optionally referred to as a genus, where metadata links are particular types of metadata; hence, the metadata links are species of metadata.

The seven cases described here are provided for clarity of presentation without loss of generality; generally, any number of cases linking the current patent application 3351 to the first office action 3620 are possible.

Generally, the first metadata link 3671 is optionally a vector, matrix, and/or set of metadata links, such as key value pairs, such as greater than 0, 1, 2, 3, 5, 10, 15, 25, 50, 100, 250, or 500 metadata links.

### Example II

Still referring to FIG. 36, a second linking example is illustrated. Generally, any element of a first office action 3620 is linked to any element of a first response 3640, such as in a given file wrapper, with a second metadata link 3672. Again, several cases illustrate second metadata links, which are optionally referred to as metadata. A metadata link optionally links a common element in two or more sections of a file wrapper, such as section with a first, second, third, . . . , and n^{th} date, where n is any date.

In a first case, a second metadata link 3671 links any element of claim 1 3621 to a first amended claim 3642. For example, the first office action 3620 may result in a claim rejection 3634 of claim 1 3621 citing a piece of examiner cited art 3416, where claim 1 is amended in first amended claims 3642 in a first response 3640. Linking the claim, reasons for rejection, and/or the amended claims together with one or more second metadata links 3672 aids in training/tuning the artificial intelligence model 710. For instance, the metadata links together: why claim 1 3621 was rejected with examiner cited art 3416; if claim 1 3621 resulted in a claim objection 3632, a claim rejection 3634, or a reason for allowance, such as in a notice of allowance 3626; if an examiner outcome of claim 1 3621 was argued against in the first response 3640; and/or if claim 1 3621 amended in first amended claim 3642 in the first response 3640. Naturally, these outcomes have corresponding example for claim 2 to claim n 3629, where n is a positive integer greater than one. Examples of metadata links/metadata include words, clauses, and/or phrases cited in the above sections, such as corresponding to arguments made by the examiner and/or attorney in reference to any section of the MPEP and/or a cited MPEP 1126 section/paragraph/element. Again, the specific metadata to the keywords identified by the examiner/attorney in arguing a claim aids training of the artificial intelligence model 710/use of the artificial intelligence model 710.

Again the cases described here are provided for clarity of presentation without loss of generality; generally, any number of cases linking the first office action 3620 to the first response 3640 are possible.

Generally, the second metadata link 3672 is optionally a vector, matrix, and/or set of metadata links, such as key value pairs, such as greater than 0, 1, 2, 3, 5, 10, 15, 25, 50, 100, 250, or 500 metadata links.

### Example III

Still referring to FIG. 36, a third linking example is illustrated. Generally, any element of a first response 3640, such as first amended claims 3642, is linked to any element of the first office action 3620, such as with third metadata links 3673. For instance, any element, word, clause, and/or phrase used by the attorney in the response in a section linked to/proximate to any section of the MPEP and/or a cited MPEP 1126 section/paragraph/element, such as in the response and/or in the prior office action is optionally and preferably used as metadata, which aids the artificial intelligence model 710 in making a connection between a given claim, amendments to the given claim (in an amended claim), a reason for rejection of the given claim, and/or an outcome, such as a reason for allowance and/or a reason for a notice of allowability to the amended claim. For instance, a new word added to a claim in the response is used as metadata, where the new word as metadata is attached to both the response, such as the first response 3640, and the prior office action, such as the first office action 3620, such as with in two key-value pairs. Generally, associating the same metadata with two documents loaded into the artificial intelligence model 710 is an example of paired/linked metadata.

### Example IV

Still referring to FIG. 36, a fourth linking example is illustrated. Generally, a metadata link optionally links a common element, number, word, clause, phrase, cited art, and/or cited art section occurring anywhere in the file wrapper and preferably in two or more sections of a file wrapper, such as sections with a first, second, third, . . . , and n^{th} date, where n is any date. For instance the same metadata word, clause, phrase, number, and/or reference to art is cited in/provided with, such as in key-values pairs, in uploaded text of/within any two or more of: the specification, a claim/a claim set, an abstract, a drawing, an office action, an amended claim/amended claim set, a response, and/or a notice, such as a notice of allowability and/or allowance. Notably, the keyword cited in metadata might be extracted from an examiner argument, such as in cited art and/or in reference to any section of the MPEP and/or an attorney argument, such as in comments and/or in an amended claim, where the keyword cited is back applied as metadata to an earlier section of the file wrapper, such as the specification. Thus, the artificial intelligence model 710 is optionally trained by experts/expert outcomes, such as from the examiner, attorney, and/or a case outcome, such as allowance or abandonment, to key to an earlier submitted section of the file wrapper, such as any section of the application as filed, such as the title, specification, claims, abstract, drawing, information disclosure statement, and/or application data sheet as filed/amended. Additional examples are provided here to further illustrate the use of metadata used as links between more than one section of the file wrapper.

### Example I

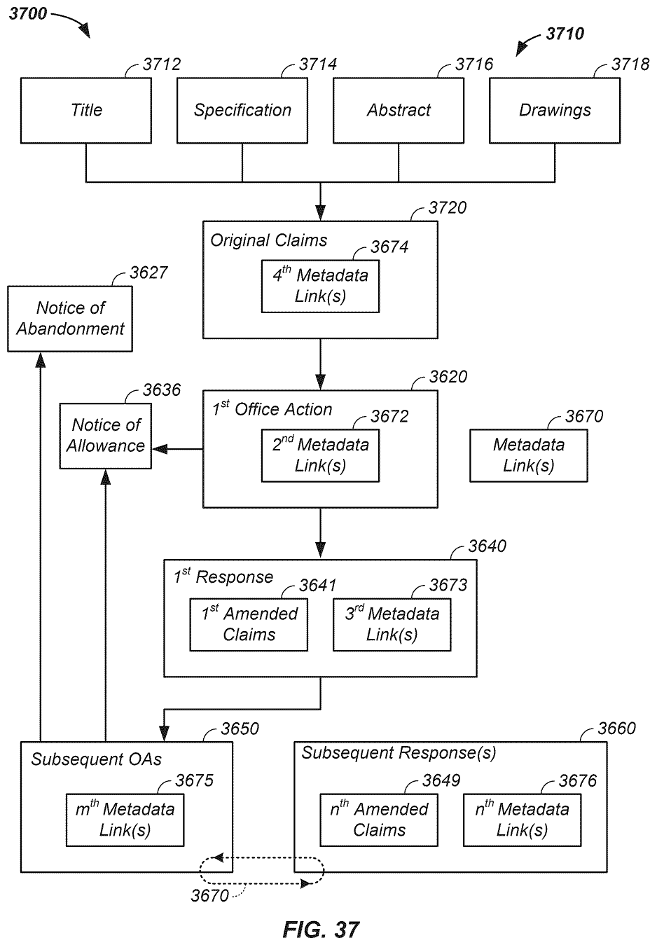

Referring now to FIG. 37, cross-section use of metadata 3700 is illustrated. Generally, metadata/metadata links 3670, such as first metadata links 3671, second metadata links 3672, third metadata links 3673, fourth metadata links 3674, m^{th} metadata links 3675, and/or n^{th} metadata links 3676/metadata are captured in/from any section of the file wrapper and/or art cited therein, such as in the patent section 3710, such as a title 3712, a specification 3714, an abstract 3716, a drawing 3718; in original claims 3720; in a first office action 3720; in a first response 3640; in a subsequent office action/subsequent office actions 3650; in a subsequent response/subsequent responses 3660; in first amended claims 3641; in n^{th} amended claims 3649; in an outcome, such as in a notice of allowance 3636, a notice of reasons for allowability, and/or a notice of abandonment 3627; and/or in a cited section of art/prior art, where the determined metadata is then optionally and preferably cited with/tagged with any 1, 2, 3, 4, 5, or more sections of the given file wrapper submitted to the artificial intelligence model 710, such as where the one or more sections optionally have differing dates in an associated file wrapper. For instance, (1) the fourth metadata links 3674 link any patent section 3170 and/or the original claims to the first office action 3620; (2) the second metadata links 3672 link any element of the first office action with the prior original claims and/or an outcome, such as the notice of allowance 3636, the first response 3640, and/or the first amended claims 3641; (3) the third metadata links 3673 link any element of the first office action 3620 to any element of a subsequent office action 3650; (4) more generally, m^{th} metadata links 3675 link to any subsequent office action 3650 to a prior response, such as first response, to a subsequent response 3650; (5) n^{th} metadata links 3676 prior office actions with subsequent response in a claim examination—claim response loop 3670; and (6) the metadata/metadata links 3670 optionally link together any two or more sections of the file wrapper with differing dates. Optionally, any drafts, related to a file wrapper, prepared by the attorneys, agents, and/or examiners are optionally and preferably loaded into the artificial intelligence model 710.

### Example II

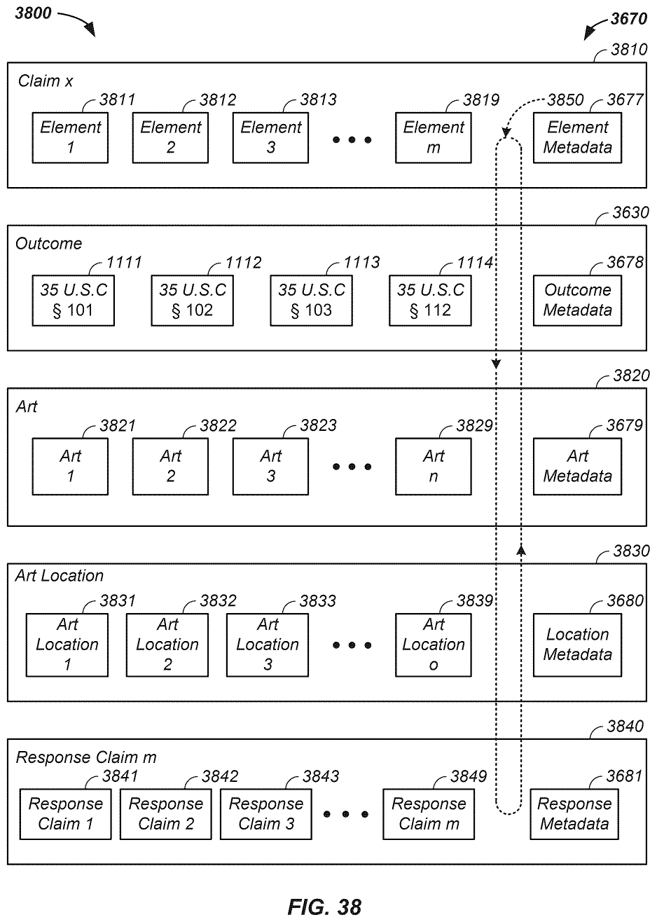

Referring now to FIG. 38, claim level/office action claim level metadata 3800 is illustrated. Generally, a given claim, such as Claim x 3810, contains a number of elements, such as a first element 3811, a second element 3812, a third element 3813, and an m^{th} element 3819, where each element is optionally used as metadata/element metadata 3677, where m is a positive integer. For example, Claim x reading in part: “a synchrotron comprising a magnet and a coil” has at least first, second, and third elements to a synchrotron, a magnet, and a coil, respectively, where each element is optionally used as metadata, in this case a species of metadata referred to as element metadata for clarity of presentation. For each Claim x 3810, an outcome 3630 is presented, such as in an office action, by the examiner, such as an outcome 3630 related to 35 U.S.C. § 101 1111, 35 U.S.C. § 102 1112, 35 U.S.C. § 103 1113, 35 U.S.C. § 112 1114; and/or a notice of allowance, where the outcome 3630 optionally and preferably is used as metadata, such as a species of metadata referred to, for clarity of presentation, as outcome metadata 3678. Again, the outcome metadata 3678, such as an outcome 3630 related to a notice of allowability, is optionally filed as metadata, such as “allowable”, along with Claim x 3810 and/or element m 3819 of claim x 3810, which aids the artificial intelligence model 710 in determining which words in a claim lead to allowance, such as in a given class, subclass, CPC classification, and/or art unit. Similarly, for claim x 3810, art 3820, such as prior art 2042, is often cited in an office action, such as first art 3821, second art 3822, third art 3823, . . . , n^{th} art 3829, where n is a positive integer. Again, each piece of art is optionally referred to in the form of art metadata 3679. For instance, a piece of cited art with inventors of Carmona is optionally referred to as “Carmona” in metadata. The art is optionally and preferably loaded in part and/or in its entirety to the artificial intelligence model 710, such as with the same metadata tag. Further, for each piece of art 3820, a particular art location is often cited, such as a first art location 3831, a second art location 3832, a third art location 3833, . . . , an o^{th} art location 3839, where o is a positive integer. Hence, for clarity of presentation, if for claim x, a first element 3811 and a second element 3812 are cited in a 35 U.S.C. § 102 1112 rejection in view of first art 3821 at a given location, such as at page x, line y, reading z, then elements of z, pulled from the cited art, are optionally used as metadata or more specifically with species location metadata 3680. Thus, in this example, the element z metadata, such as reading “a synchrotron with magnets” in the first art 3821 at the first art location 3831 includes all of the claim x elements of “synchrotron” and “magnet”, each used as location metadata 3680. The location metadata is optionally and preferably loaded into the artificial intelligence model 710, such as with metadata tags to CPC class, class, subclass, art unit, and/or a 35 U.S.C. § 102 rejection as training that a synchrotron with a magnet is not new. Again, the cited art, in part or whole, is also optionally loaded into the artificial intelligence model 710 with the associated location metadata tags. Similarly, if the third element 3813, such as to a “dynamic betatron oscillation, yields an outcome 3630 of allowed, then the artificial intelligence model 710 is trained, through metadata tags, that the element m 3819, such as to the clause “dynamic betatron oscillation” is likely novel for metadata tagged classes of CPC class, class, sub-class, art unit, and filing date. Again, training, such as for multiple patents, claims, and outcomes, such as in a training routine 3850, with greater than thousands, millions, tens of millions, hundreds of millions and/or billions of claim elements associated with CPC classes, classes, sub-classed, and/or art units, especially when tagged with related species metadata tags, trains the model to determine novelty, likely novelty, non-novelty, and/or reasons for non-novelty, such in any of: the unofficial office action generator 510, the unofficial response generator 1510, the binary analyzer 1412, the probability analyzer 1414, the unofficial office action model 714, the unofficial office action 2510, search results 57, and/or in the artificial intelligence model 710.

### Metadata Determination/Selection

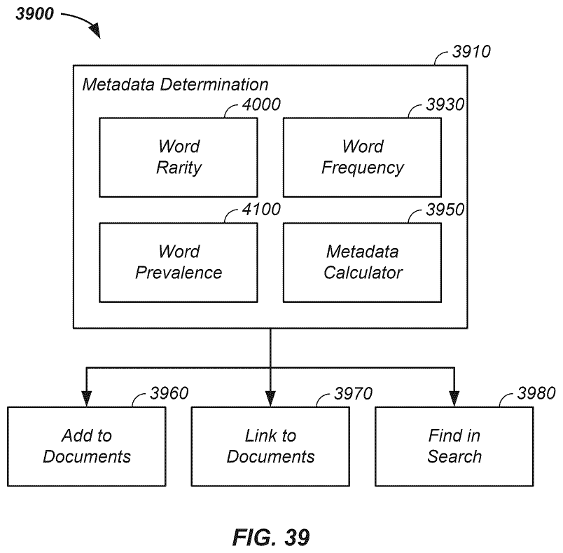

Referring now to FIGS. 39-42, metadata determination, such as metadata determination from claims is described.

Referring now to FIG. 39, a system of metadata linking 3900 is illustrated, such as linking metadata to the artificial intelligence model 710 and/or a system using an AI model. More particularly, metadata determination 3910 is described. Metadata 3700 is optionally extracted from a given claim based on word rarity 4000, word frequency 3930, word prevalence 4100, and/or with a metadata calculator 3950, each of which are further described infra. Once metadata 3700 is determined, the metadata is optionally added to any document 710 and/or linked to any document 3970, where the document is any data, text, and/or figure uploaded to the artificial intelligence model 710, such as a corresponding claim set, a corresponding specification, and/or a corresponding drawing. Similarly, the metadata is optionally included with/attached to any document used to train the artificial intelligence model 710. Similarly, the metadata 710 is optionally attached to any document 3960 and/or linked to any document 3970 used by the artificial intelligence model and/or searched by the artificial intelligence model, where again the document is any data, text, and/or figure. Similarly, the metadata 3700 is optionally used in a process of finding in a search 3980 a result, such as a search using the artificial intelligence model 710. Generally, metadata determination 3910 is optionally and preferably repeated for individual claims, claim set, classes of claims, and/or for a subset/all claims in a given patent and/or patent class. Several examples further described word rarity 4000, word frequency 3930, word prevalence 4100, and the metadata calculator 3950.

### Example I

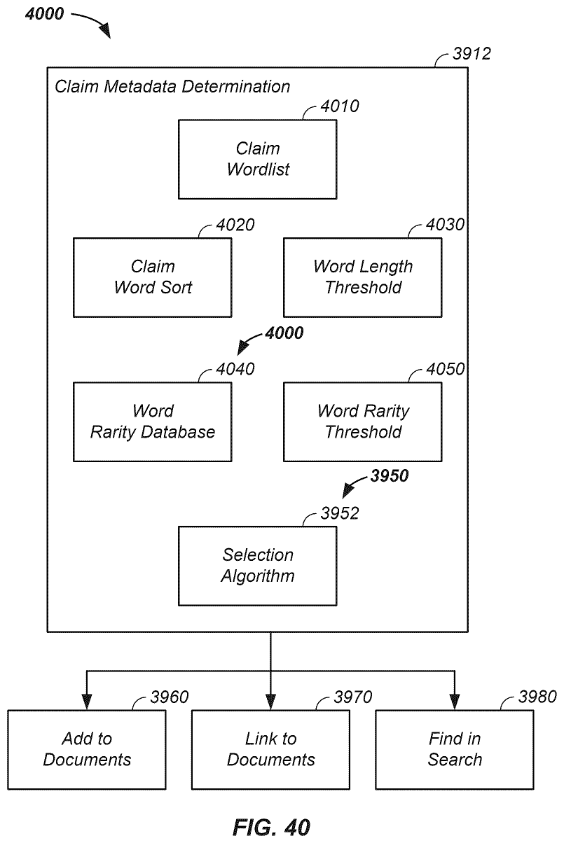

Referring now to FIG. 40, word rarity 4000 is further described. More particularly, claim level metadata determination 3912 is described. Generally, for a given claim, claim list, and/or claim set a claim wordlist 4010 is generated. The Claim wordlist 4010 is optionally sorted in any manner, but this step is not required. For clarity of presentation and without loss of generality, the claim wordlist 4010 is sorted in terms of number of characters in each word, phrases, and/or clauses in the claim wordlist 4010, such as the word “a” has one character and the word “cancer” has six characters. A word length threshold 4030 is optionally set, such as only proceed with words having greater than 2, 3, 4, 5, 6, or more characters. The word rarity 4000 is optionally assessed by any means, such as with a word rarity database 4040. For instance, frequency of words in the English language are each measured and tabulated into a frequency database, referred to here as a word rarity database. A word rarity threshold 4050 is optionally used to further filter the claim wordlist 4010, such as only selecting words with a frequency of use of less than 0.1, 0.08, 0.06, 0.04, 0.02, 0.01, 0.001, 0.0001, 0.00001, or 0.000001 uses per million words in a given language, such as English, in technical literature, in field related literature, in a CPC class, in art in the field, in web posts, and/or in books any of which are optionally included in the word rarity database 4040. The metadata calculator 3950 is then optionally used with or without a selection algorithm 3952 to select the claim level metadata 3912 used as metadata 3700 added to/linked to/and/or searched with any artificial intelligence related tool, as described supra.

Referring now to Tables 1-6, for clarity of presentation and without loss of generality, the claim metadata determination 3912 process is described with specific claim language. For ease of presentation, the illustrated claim is limited to twelve words, which are the claim words in Table 1. Table 1 also provides the word rarity, illustrative numbers are used, for each claim word in column 2, such as obtained from the word rarity database 4040. Word rarity is optionally referred to as frequency of use of a word.

TABLE 1
Claim Word Rarity

| | Word Rarity |
|---|---|
| Claim Words | (per million) |
| a | 2,000 |
| and | 1,000 |
| said | 0.01 |
| cancer | 0.12 |
| proton | 0.03 |
| particle | 0.035 |
| platform | 0.06 |
| betatron | 0.00001 |
| computer | 0.05 |
| extraction | 0.04 |
| Lambertson | 0.0001 |
| synchrotron | 0.01 |

Table 2 presents elements of Table 1 after the claim word sort 4020 step; in this case only words with greater than five characters are selected, which narrows the claim wordlist 4010 to nine words. Further, in Table 2, the remaining words in the claim wordlist 4010 are sorted in terms of word rarity 4000, any of which could be used as metadata 3700.

TABLE 2
Claim Word Rarity

| | Word Rarity |
|---|---|
| Claim Words | (per million) |
| platform | 0.07 |
| computer | 0.06 |
| extraction | 0.05 |
| cancer | 0.05 |
| particle | 0.035 |
| proton | 0.03 |
| synchrotron | 0.01 |
| Lambertson | 0.0001 |
| betatron | 0.00001 |

However, in this illustrative case, the word rarity threshold is set to less than 0.001 occurrences per million words, which results in only two words being selected as metadata, the words “Lambertson” and “betatron”, which is an example of a result from the selection algorithm 3952.

### Example II

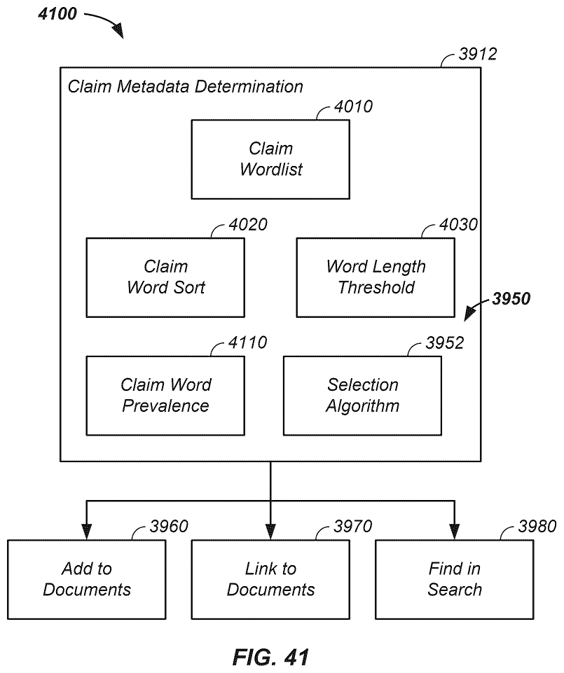

Referring now to FIG. 41, word prevalence 4100 is further described. More particularly, claim level metadata determination 3912 is described in terms of word prevalence, where prevalence refers to how often a word, clause, and/or phrase is present in a given claim, claim set, class, text, and/or document, such as a specification. Again, as in Example I, generally, for a given claim, claim list, and/or claim set a claim wordlist 4010 is generated, the claim words are optionally sorted 4020, and the claim word prevalence 4110 is determined. Here, for clarity of presentation, the same twelve claim words are analyzed with the selection algorithm 3952. Table 3 provides the illustrative prevalence of each word in the illustrative claim and Table 4 provides the sorted claim wordlist 4010 after removal of words with five or fewer characters.

TABLE 3
Claim Word Prevalence

| | Word Prevalence |
|---|---|
| Claim Words | (in Claim) |
| a | 8 |
| and | 2 |
| said | 7 |
| cancer | 1 |
| proton | 1 |
| particle | 2 |
| platform | 6 |
| betatron | 1 |
| computer | 1 |
| extraction | 2 |
| Lambertson | 1 |
| synchrotron | 3 |

TABLE 4
Sorted Claim Word Prevalence

| | Word |
|---|---|
| Claim Words | Prevalence |
| platform | 6 |
| computer | 1 |
| extraction | 2 |
| cancer | 1 |
| particle | 2 |
| proton | 1 |
| synchrotron | 3 |
| Lambertson | 1 |
| betatron | 1 |

From Table 4, after a word prevalence threshold of greater than five instances is applied, such as set in the selection algorithm 3952, the single word “platform” is selected as metadata 3700, where the word prevalence threshold is set to greater than 1, 2, 3, 4, 5, 6, 8, 10, 15, 20, 50, 100, 250, 500, or more instances of the word, clause, or phrase in the claim/claim list.

### Example III

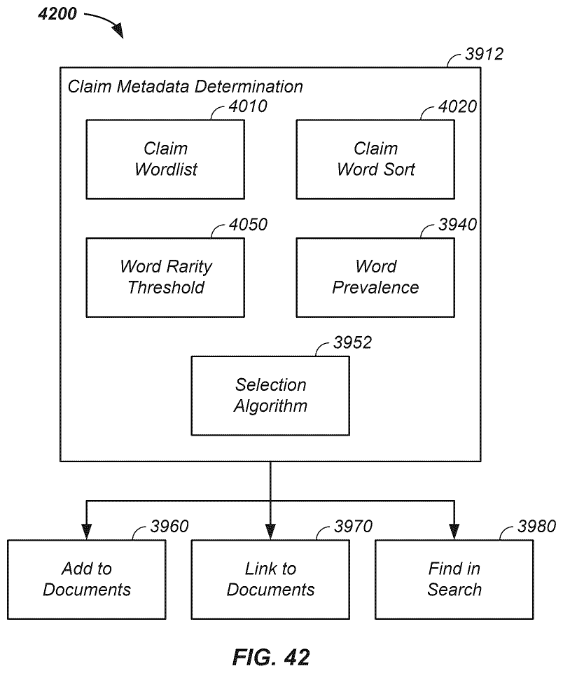

Referring now to FIG. 42, in a third example, the metadata calculator and/or the selection algorithm 3952 uses both word rarity 4000 and word prevalence 4100/claim word prevalence 4110. Again, for clarity of presentation, the same twelve words in the claim wordlist 4010 are used. Table 5 provides, after removal of words below a word length threshold 4030 of greater than five characters, the claim wordlist 4010 along with associated word rarity 4000 and claim word prevalence 4110. From Table 5, a higher (relative to Example I) word rarity threshold 4050 of less than 0.06 is used where the selection algorithm 3952 further requires a claim word prevalence 4110 of greater than 1, which results in the selection of the words “extraction”, “particle”, and “synchrotron”, where again the results are an example of output from the selection algorithm 3952.

TABLE 5
Claim Word Rarity and Frequency

| | Word Rarity | Word Prevalence |
|---|---|---|
| Claim Words | (per million) | (in claim(s)) |
| platform | 0.07 | 6 |
| computer | 0.06 | 1 |
| extraction | 0.05 | 2 |
| cancer | 0.05 | 1 |
| particle | 0.035 | 2 |
| proton | 0.03 | 1 |
| synchrotron | 0.01 | 3 |
| Lambertson | 0.0001 | 1 |
| betatron | 0.00001 | 1 |

Referring again to Examples I, II, and III, a combined list of metadata 3700, in Table 6, from the metadata determination 3910 includes the words: “Lambertson”, “betatron”, “platform”, “extraction”, “particle”, and “synchrotron”, which is a good keyword list that is optionally and preferably auto-extracted with computer code applied to a claim, claim list, and/or claim set, such as with the above described adjustable algorithm.

TABLE 6
Auto Selected Metadata

| | Word | Word | Metadata |
|---|---|---|---|
| Claim Words | Rarity | Prevalence | Calculator |
| platform | | X | |
| computer | | | |
| extraction | | | X |
| cancer | | | |
| particle | | | X |
| proton | | | |
| synchrotron | | | X |
| Lambertson | X | | |
| betatron | X | | |

Notably, the metadata extraction algorithm(s) are optionally applied to any text. For example, internal reports, such as engineering reports, are optionally searched for metadata. The extracted metadata is optionally not metadata, but instead is optionally referred to as keyword data/extracted keyword data. The extracted/selected keyword data, such as from one or more reports, internal reports, documents, and/or engineering/science documents are then optionally combined in any number and/or combination, where the various combinations of keywords are then analyzed for patentability, such as in the form or an automated keyword search and/or keyword combination 2012, such as described supra. Similarly, the determined keywords are optionally used in the artificial intelligence patent proposal system 1310; are assessed against a 35 U.S.C. 101/102/103 rejection in the form of an unofficial office action, such as generated by the unofficial office action generator 510; are included in the database 50; are used in the inception testing system 300/inception tester 310; and/or are fed to the artificial patent proposal 1310 system, each of which are described herein. The testing of the extracted metadata/keywords for patentability is optionally automated/semi-automated, which allows vast numbers of combinations to be tested for patentability (and preferably sorted), which allows industry, government, academics, and/or individuals to quickly, efficiently, and/or accurately review documents for patentability, which allows informed decisions, such as financial decisions, to be made as to: what to patent, what trade secrets to release (as probability of patentability is optionally and preferably determined, how to block competitors, how to impede competitors own intellectual property protection, and what to maintain as trade secret.

Optionally, the determination of word rarity and/or word prevalence is applied to a patent application, such as a filed specification, and/or to an engineering report.

### CPC Identification/CPC Searching

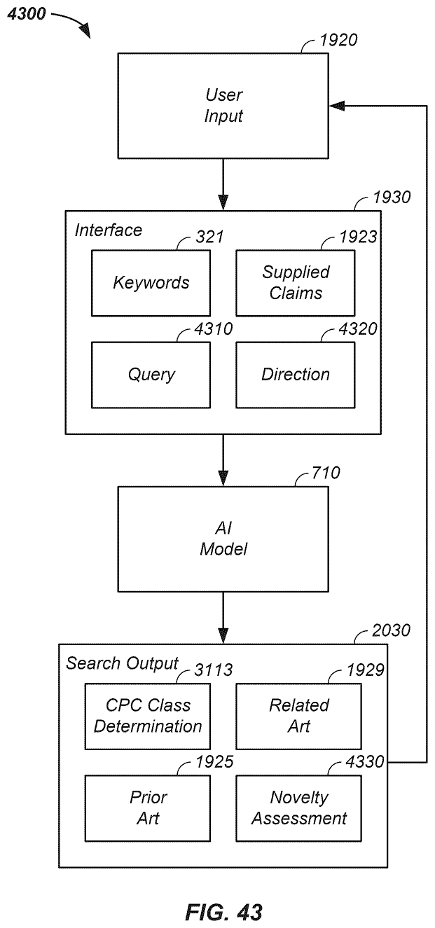

Referring now to FIGS. 43-49, patent searching is described. For clarity of presentation and without loss of generality, use of the model 700 to search the Cooperative Patent Classification (CPC) of patents is demonstrated. However, the breakdown of patents into levels, such as in a hierarchy, and searching one or more levels of the breakdown of patents is logically extended into other fields, such as any field broken down into a hierarchal structure, such as a classification of vehicles into levels, such as cars, engines, air intake, and controllers. As described below, this limit hallucinations of the model and allows for more detail in a given model as the model is optionally implemented with more detail at its most detailed lowest hierarchal level.

Generally, the CPC divides patents into a hierarchal structure of: sections, classes, sub-classes, groups, and sub-groups. While the CPC classification is described herein, the description is readily applied to any classification, past or present, such as that used by the European Patent Office, the Japanese Patent Office, and/or the U.S. Patent and Trademark Office. The CPC levels of classification are further described, infra. Notably, any published work is optionally included in this hierarchal structure, which allows a search of patents in a sub-group, group, and/or sub-class to include a search of any published document in the sub-group, group, and/or sub-class. For instance, a search of a group is readily configured to search all of the sub-groups of the group, such as by simply including in a data set/datastore all of the sub-group information in the group. Similarly, a search of a sub-class is readily configured to search all of the groups and sub-groups of the sub-class.

Referring again to FIG. 43, an art/class/novelty determination system 4300 is illustrated. Generally, an example of the user interface system 1900, such as described supra, is illustrated here with a user providing user input 1920 to an interface 1930, such as a user interface. Examples of user input 1920, which is optionally automated/semi-automated, is illustrated here with keywords 321, supplied claims 1923, a user query 4310, and/or a user direction 4320, though any input is optionally used, into the artificial intelligence model 710 and/or any model/database/tuning system linked thereto. For instance, a supplied claim 1923 is input into the model 700 and the model analyzes the supplied claim 1923, such as with a neural network 600, a vector, an embedding, a distance, and/or a database, and produces an output, such as a search output 2030. Examples of search outputs include: a CPC class determination 3113, related art 1929, prior art 1925, and/or a novelty assessment 4310 of the claim, where the novelty assessment 4330 optionally includes an anticipation and/or an obviousness analysis of the claim. The art/class/novelty determination system 4300 is further described, infra.

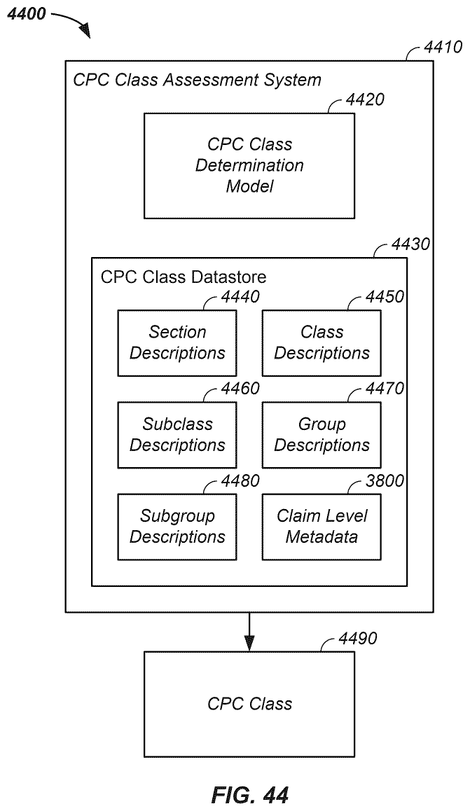

Referring now to FIG. 44, often an optional first step is a determination of a CPC class 4490 of the invention, such as through use of keywords 321 and/or a supplied claim 1923. Here, a CPC class determination system 4400 is illustrated that optionally and preferably uses a CPC class assessment system 4410 to determine a CPC class 4490 associated with the supplied keywords 321 and/or the supplied claim 1923. Generally, the CPC class assessment system 4410 optionally and preferably uses a CPC class determination model 4420, which is an example of the model 700, the artificial intelligence model 710, and/or data and/or a datastore linked to the models. For example, the CPC Class determination model 4420 is optionally associated with and/or is previously trained with a CPC class datastore 4430, such as populated with one or more of: section descriptions 4420, class descriptions 4450, subclass descriptions 4460, group descriptions 4470, subgroup descriptions 4480, and/or claim level descriptions/claim level metadata 3800. Illustrative examples follow.

### Example I

An example of a CPC class is: A01B 33/00, which is broken down here. In the CPC code, the patents, patent publications, and/or any related art, are structured hierarchically with each level progressively detailing the technology. For the given exemplary class of A01B 33/00:
the first letter is a “section”, such as from A to H, or Y for new technologies, where the illustrative “A” is to a human necessities section;
the following two-digit number is a “class”, such as the exemplary “01”, which refers to agriculture; forestry; animal husbandry; trapping; fishing;
the next letter refers to a “subclass”, which further specifies the technology; the exemplary “B” refers to soil working in agriculture or forestry, parts, details, or accessories of agricultural machines or implements;
the following 1 to 4 digit number is a “group” that defines a more specific area; here the “33” refers to tilling implements with rotary driven tools; and
after an oblique stroke, a subgroup is referred to with a number of at least two digits, which represents a still more specific level of detail; here the “00” represents the subgroup description.

Optionally, the CPC class descriptions, such as at the group/subgroup level is supplemented with the claim level metadata 3800/claim level keywords, as further described infra.

### Example II

The main Cooperative Patent Classification (CPC) for charged particle cancer therapy is in A61N 5/10 (particle-irradiation therapy), which falls under A61N (Radiation therapy). More specific subclasses can be found within this, such as A61N 5/1048 for Monitoring, verifying, and controlling systems for particle therapy, A61N 5/1049 for patient positioning monitoring, verification, and controlling relative to a radiation beam during radiotherapy, and G21K 1/00 for general arrangements handling charged particles and radiation. This example illustrates that multiple sub-classes are related, so searching related classes is often beneficial. Again, metadata to any section, class, subclass, group, and/or subgroup is optionally used to aid in searching the data. Similarly, computer code that parses a given CPC metadata tag is optionally used, such as select the “G”, “G21”, “G21K”, and/or “G21K1” in this example.

Referring again to FIGS. 43 and 44, the model 700 is optionally and preferably trained with and/or associated with a dataset, such as a datastore, for each of one or more and preferably every cooperative patent classification, such as at the lowest subgroup and/or group level. Then, the model 700 can take the supplied claim 1923 and output the associated class, such as with a CPC class determination model 3113; can find related art 1929, such as art in the identified CPC class 4490; can find prior art 1925, such as art in the identified CPC class 4490 with a date prior to the pre-filing date 2022; and/or is used in a novelty assessment 4310 as further described infra. Typically, a first use of the model 700 is to determine the CPC class 4490 for the invention and a second use of the model 700 is to search the identified CPC class 4490 for information, though the first step is optional. For instance, in preparation of the model 700, referring now to FIG. 44, the CPC class determination model uses a dataset, also referred to herein as a datastore, with CPC descriptions to each section 4440, class 4450, subclass 4460, group 4470, and/or subgroup 4480. The subclass 4460, group 4470, and/or subgroup 4480 are optionally associated with keywords extracted from the specification and preferably from claims, such as the independent claim for each patent, in each subclass 4460, group 4470, and/or subgroup 4480, which aids the model 700 in assigning the supplied claim 1923 to the appropriate CPC class 4490 in a semi-automated/automated fashion. Establishment of the keywords, also referred to as claim level metadata 3800, is further described infra, optionally and preferably in an automated method.

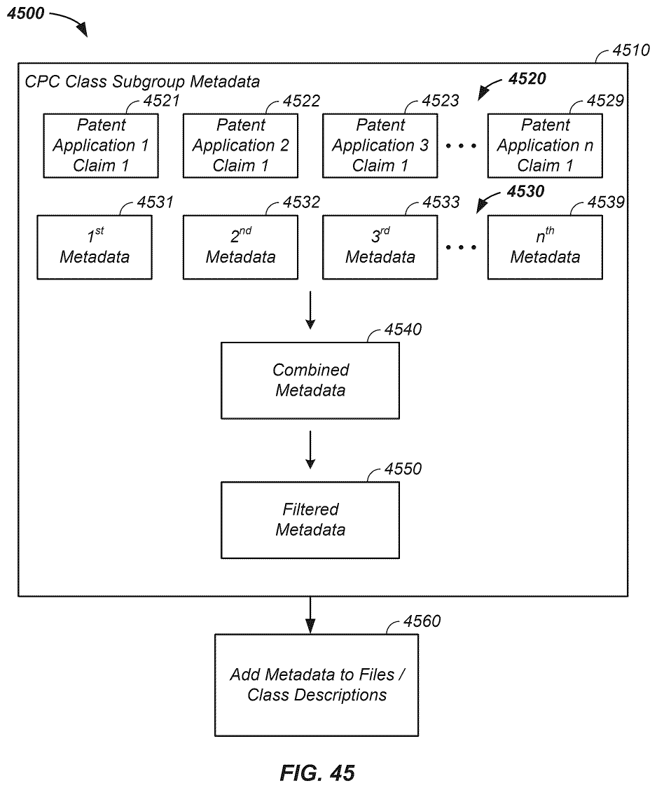

Referring now to FIG. 45, a claim level CPC class determination system 4500 is illustrated. Generally, CPC class subgroup metadata 4510/keywords are optionally extracted from existing patents assigned to the sub-class. For instance, claim 1 of a first patent application 4521 has first metadata 4531, such as identified by word length, word rarity, word prevalence, and/or one or more thresholds, as described supra. Similarly, within the same subgroup, group, and/or subclass, claim 1 from each of a second patent application 4522, a third patent application 4523, and an n^{th} patent application 4529 yields second metadata 4532, third metadata 4533, and n^{th} metadata 4539, respectively, where n is a positive integer. The metadata/keywords from the n claims is optionally combined to form combined metadata 4540. For clarity of presentation, herein metadata is optionally used as keywords and vice versa. The combined metadata 4540 is optionally filtered 4550, as described infra. The combined metadata 4540 and/or the filtered metadata 4550 is optionally and preferably added to the CPC class descriptions 4560, which again further aids the model 700 determining correct subclasses for the supplied keywords 321 and/or the supplied claims 1923. An example of the filtered metadata 4550 follows. Again, the metadata is optionally and preferably used to supplement the CPC descriptions at the lowest 1, 2, and/or 3 hierarchal levels.

### Example I

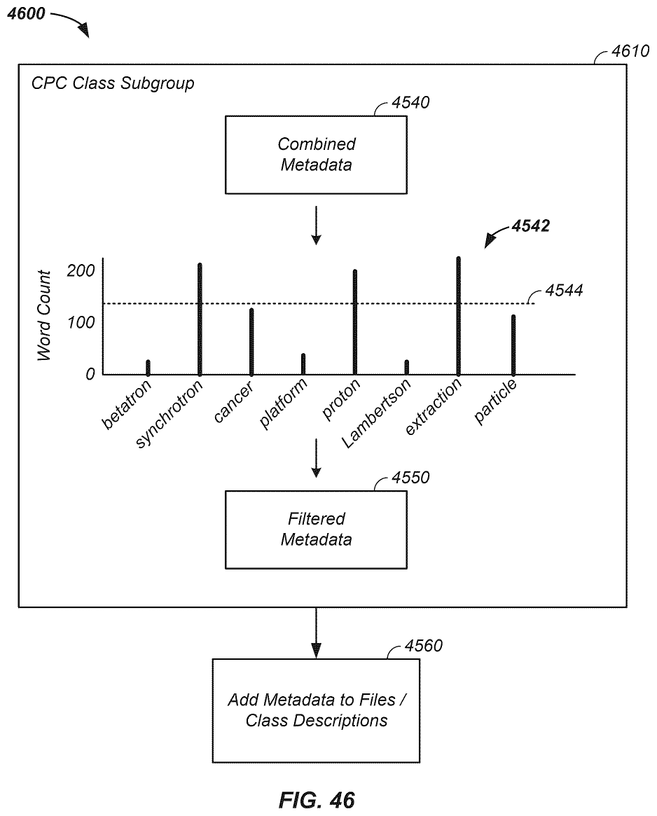

Referring now to FIG. 46, a supplement subgroup description system 4600 is illustrated. For a given CPC class subgroup 4610, the combined metadata 4540 is optionally analyzed. In this example, provided for clarity of presentation and without loss of generality, for the n claims in the given subgroup 4610, a number of uses of each extracted word 4542, clause, and/or phrase is counted. Extremely rare words, such as betatron, likely represent novelty as opposed to a class description. Conversely, commonly used words, with a sufficiently long length and/or with a sufficient rarity, in the CPC class subgroup 4610 likely describe the subgroup. Hence a use threshold 4544 is set, such as greater than 10, 50, 100, 200, 300, 400, 500, or 1000 and/or less than 5000, 4000, 3000, 2000, 1000, or 500 uses in the CPC class subgroup. Here, the words synchrotron, proton, and extraction, which are used more than 130 times in this example, are selected as keywords/metadata, where the words, clauses, and/or phrases are used to further described the given CPC class subgroup 4610, such as in data provided to the model 700. Logically, this process is repeated for any given subgroup, group, or class, with increasing word count thresholds for the broader group description 4470 and subclass description 4460, such as a second wordcount threshold and third wordcount threshold, respectively. Again, extraction or keywords from the claims, such as the first claim and/or any independent claim supplements the CPC descriptions, such as at a subgroup level, which aids the model 700 in properly assigning a CPC class to provided user input, such as a set of keywords and/or a claim.

Again, notably, the CPC system is optionally and preferably supplemented with any printed/published document. For instance, a publication is optionally classified with the CPC system and is thus optionally found in the CPC hierarchal structure, which is optionally referred to as a publication supplemented CPC class. Stated again, just like a patent is classified by the CPC system, non-patent literature and/or any publication is optionally classified by the CPC system. Thus, a search of non-patent literature of CPC classified documents is now possible, such as part of a search and/or as part of an unofficial/official office action.

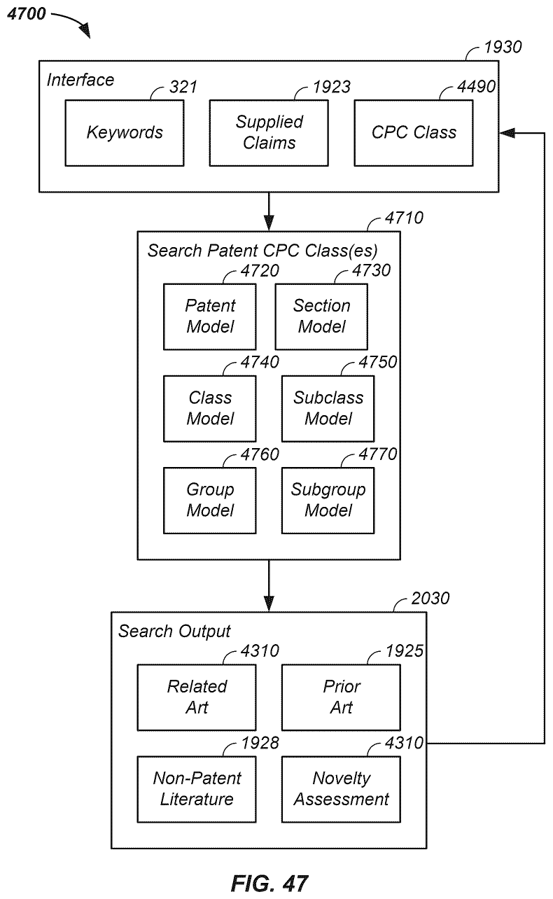

Referring now to FIG. 47, now that a CPC class 4490 has been determined, a CPC search system 4700 is illustrated. As illustrated, in the CPC search system 4700, keywords 321 and/or supplied claims 1923, optionally and preferably with the previously identified CPC class 4490, such as determined above, are supplied via an interface 1930 to the model 700, such where the model 700 searches the identified CPC class(es) 4710, such as with a patent model 4720, such as including all patents/publications; a section model 4730, such as including all patents in the section; a class model 4740/class datastore, such as including all publications in the class; a subclass model 4750, such as containing all references in the subclass; and/or similarly a group model 4760 and/or subgroup model 4770, such as each with a group datastore/subgroup datastore, respectively. Stated again, more specific models are optionally used for a search than a global model, which mimics how a patent examiner reviews a claim. The more specific models/more specific datastores are in lower structures of the CPC classification system. for instance, each section, class, subclass, group, and/or subgroup optionally has it own model and/or its own datastore. The more specific models, such as a model using a datastore to a group and/or a subgroup, is optionally used to limit hallucinations of the model 700, such as when query answers are limited to the narrower levels. In place of a large CPC datastore, multiple small datastore are optionally implement, such as to a given section, a given class, a given subclass, a given group, and/or a given subgroup. Again, identifying the appropriate datastore to match a claim classification reduces search latency and reduces costs. Conversely, datastores are built for the bottom 1, 2, 3, or 4 layers of the CPC classification system, where the smaller datastore are concatenated/joined as needed in a search. For example, group/subgroup datastores are joined to for a subclass group. Examples are used to further clarify the CPC search system 4700.

### Example I

For clarity of presentation and without loss of generality, a first example of addressing model hallucinations is provided. In the art of cancer therapy, a “couch” refers to a patient positioning system used to reduce movement of the patient during treatment with a particle beam, which is to a first CPC class. However, the word “couch” is commonly used in reference to living room furniture, which is to a second CPC class, where even at higher levels in the CPC system, the first and second CPC classes are distinct. Once the artificial intelligence model 710 is limited to answers from the correct CPC classification, as described above, and/or with or without the use of metadata to CPC levels, with the use of separate data stores of patents/publication to each classification, an artificial intelligence hallucination of a couch reference from the living room classification is not possible when querying the data sets/datastores associated with cancer therapy as answers are optionally and preferably limited to references from the cancer therapy CPC classification(s). Thus artificial intelligent hallucinations are controlled/eliminated by searching different elements of a classification system, such as different sub-areas of the CPC classification system.

### Example II

In this example, provided for clarity of presentation and without loss of generality, the CPC search system 4700 is asked: What patent, patent publication, and/or literature, in the identified group/subgroup teaches all of the elements of this claim: [claim provided]. The model then searches the provided group/subgroup, such as in related datastore(s) and identifies any patent that teaches each of the elements of the provided claim. The formatting of the response is optionally that of a 35 U.S.C. 102 rejection in an office action.

Similarly queries are optionally used to determine a most related patent/publication, where the output indicates: (1) elements of the provided claim that are taught by the identified patent/publication, optionally stating where and/or how; and (2) elements of the provided claim that are not taught by the cited art, which is the basis of an allowance or a basis of a 35 U.S.C. 103 rejection in an office action. Again, details of the cited art, optionally and preferably included in the search output 2030, indicate why the idea/claim is novel/not novel in terms of cited art, which greatly aids the patent agent 20 in determining whether or not to pursue the idea in patent prosecution.

Naturally, the supplied claim 1923 is optionally modified and the process repeated.

### Example III

Similarly to the above example, the query asks for two or more publications/patents that combine to teach all of the elements of the supplied claim 1923, which is the basis of a 35 U.S.C. 103 rejection/response in an office action.

### Example IV

The datastore for a given group/subgroup is optionally queried to produce a report of any one or more of: related art 4310, prior art 1925, related non-patent literature 1928, a novelty assessment 4310, all of and/or a filtered output of any of the above, patent ownership of related art, and/or inventorship of related art.

### Model Levels

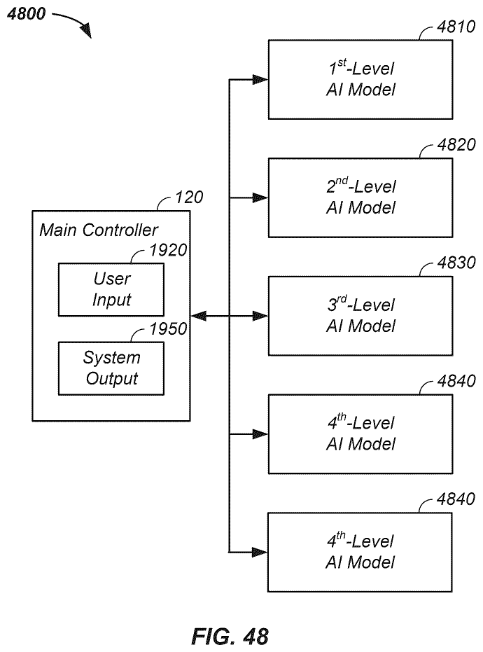

Referring now to FIG. 48, a multi-tiered model system 4800 is illustrated.

Herein, for clarity of presentation and without loss of generality, the CPC classification system is used as an example. In the CPC classification system, patents are divided into sections. A model covering all sections of the CPC classification system is an example of a first level model, such as a first level artificial intelligent model 4810. Again, a model herein is optionally an artificial intelligence model, a datastore, and/or a combination of an artificial intelligence model connected to a datastore, where optionally queries to the artificial intelligence model are grounded/limited to the datastore, are preferentially from the datastore, and/or are derived from a larger dataset, such as linked to the world wide web. In the CPC classification system, a second level model, such as a second level artificial intelligence model 4820 is to a narrower classification, such as to a section of the CPC classification system. Similarly, a third level model, such as a third level artificial intelligence model 4830, is to a still narrower classification, such as to a class of the CPC classification system. Similarly, a fourth and fifth level model, such as a fourth and fifth level artificial intelligence model 4840, 4850, are to a still narrower classification, such as to a subclass and subgroup of the CPC classification system, respectively. Thus, a second level model to a given section of the subclassification system optionally and preferably contains all information in the given section, whereas a lower level model, such as a fourth level model, optionally and preferably contains only information of a given subclass and all subgroups of the given subclass. In CPC terminology, for example, a model to a CPC classification starting in A01B (section A, class 01, subclass B) optionally and preferably includes all or greater than 10, 20, 40, 60, or 80 percent of information of the groups and subgroups xx/y of subclass B, where the model is at any level of the classification system. Similarly, a model is to an entire section, and entire class, an entire subclass, and/or an entire subgroup, such as in associated sections of the CPC classification system. Notably, other systems are similarly classified, such as a vehicle, car, engine, engine air controller hierarchy. As illustrated, the user input 1920 and system output 1950, such as in the main controller 120 are used to query the model and receive output from the model, respectively. For instance, the user input is in the form of keywords 321 and/or supplied claims 1923.

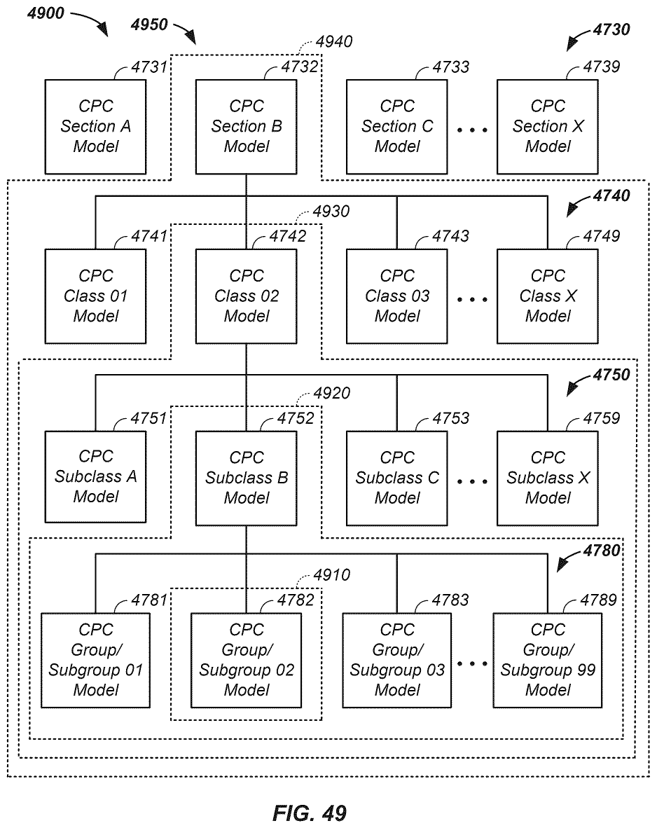

Referring now to FIG. 49, CPC level models 4900 are illustrated, which is an example of the multi-tiered model system 4800. Generally, a CPC model 4950 is optionally used that includes any portion of data in the CPC classification system. However, for clarity of presentation and without loss of generality, portions of a CPC class starting with B02B in the CPC class B02B xx/yy are illustrated.

Generally, a section model 4730 is to a given section of the CPC system, such as a CPC section A model 4731 to section A, a CPC section B model 4732 to section B, a CPC section C model 4733 to section C, and a CPC section X model 4739 to a given section of the CPC system. The CPC section B model 4732 is illustrated containing elements in a section level 4940.

For section B, a class model 4740 is to a given class of the CPC system, such as a CPC class 01 model 4741 to class 01, a CPC class 02 model 4742 to class 02, a CPC class 03 model 4743 to class 03, and a CPC class X model 4749 to a given class of the CPC system. The CPC class 02 model 4742 is illustrated containing elements in a class level 4930. Again, an exemplary metadata tag is “CPC section B, class xx” or Bxx, where xx is a two digit code, such as 01, 02, 03, . . . , or any reference to the first three digits of the CPC class or 2^{nd} and third digits of the CPC class.

Similarly, a class model 4750 is to a given model section of the CPC system, such as a CPC subclass A model 4751 to class A, a CPC subclass B model 4752 to subclass B, a CPC subclass C model 4753 to class C, and a CPC class X model 4759 to a given class of the CPC system. The CPC subclass B model 4752 is illustrated containing elements in a subclass level 4920.

Similarly, for group/subgroup 01, a group/subgroup model 4780 is to a given group/subgroup of the CPC system, such as a CPC group/subgroup 01 model 4781 to group/subgroup 01, a CPC group/subgroup 02 model 4782 to group/subgroup 02, a CPC group/subgroup 03 model 4783 to group/subgroup 03, and a CPC group/subgroup 99 model 4789 to a given group/subgroup of the CPC system. The CPC group/subgroup 02 model 4782 is illustrated containing elements in a group/subgroup level 4910.

Since in a traditional search Examiners in the U.S. Patent and Trademark Office typically search multiple subgroups of a group, a group level model is optionally and preferably preferred, which would include multiple sub-groups.

Stated again, the model/datastore is optionally to any level of the CPC classification system. Notably, if metadata datastores, or a corresponding database, are created at the subgroup level, a simple combination/concatenation of the subgroup level datastores yields a higher level datastore, such as progressively to group level datastores, subclass level datastores, class level datastores, and finally to section level datastores. Conversely, a global datastore is optionally queried at lower CPC levels via metadata usage. Combining section level datastores results in a CPC datastore. As above, the datastores are optionally artificial intelligence models for the related datastore. For instance, a subgroup artificial intelligence model is trained to a given subgroup, a group artificial intelligence model is trained to a given group, a subclass artificial intelligence model is trained to a given subclass, a class artificial intelligence model is trained to a class, a section data store is trained to a section, and CPC artificial intelligence model is trained to data in the CPC classification system.

In any model, artificial intelligence model, and/or datastore, the data in the associated system represents greater than 10, 20, 30, 40, 50, 60, 70, 80, 90, 95, or 99% of all associated data placed into the CPC system by entities, such as the U.S. Patent and Trademark Office. Data at any level is optionally and preferably updated as the associated government entity makes the data publicly available, such as via publication and/or in a published file wrapper. Optionally and preferably, the database 50 is updated more often than every 500, 400, 300, 200, 186, 185, 180, 100, 50, 32, 31, 30, 29, 15, 10, 8, 7, or 2 days.

### EXAMPLES

Generally, the model assisted patent prosecution system provides a concrete output that is a technical improvement over existing technology. For clarity of presentation and without loss of generality, examples of the concrete output include: a generated set of claims to an idea, an early unofficial patent office action to the set of claims, a generated response to the unofficial patent office action, generated amended claims, new ideas based on an input idea, and/or a freedom to operate opinion, such as for review and issuance by a patent attorney. A clear technical improvement is being provided with any of the concrete outputs on a time scale that allows business decisions within less than 1, 2, 3, 4, 5, 6, 7, 30, 60, or 90 days. For instance, the unofficial patent office action is obtained, such as for review by a decision maker, in a time period far less than expected response times from government patent offices that typically exceed 180, 360, 540, or 720 days.

Any element described herein in terms of an artificial intelligence/neural network system is optionally supplemented with traditional code and/or is replaced with traditional code.

### Database

The database 50 is further described here. Examples of data sources used in the database include: the published patent(s) 1000, the file wrappers 1100, literature 830, such as non-patent literature 1928 (NPL), and/or trade secrets. Examples of trade secrets are business internal emails, internal engineering reports, scientific results, business models, and the like.

For clarity of presentation and without loss of generality, the database 50 optionally includes: any file wrapper 1100; published patent 1000; non-patent literature 1928; keywords/key ideas shared between a string of documents, such as in a prior art search; relevance of prior art to a claim; data, such as for comparing issued patents to a product and/or such as used in a freedom to operate opinion; and/or elements, such as used in comparing a proposed patent claim with prior art, any of which apply to a range of patent/non-patent uses. Generally, computational relationships between database elements yield an approach to legal reasoning, which are optionally used to calculate the probability of certain events happening, such as those based on relationships and/or probabilities defined in the probability; to yield weighted probabilities; are optionally auditable; and/or link the probability network to the data sources, such as through use of a large language model. In one example, provided here for clarity of presentation and without loss of generality, a probability model interprets data sources through use of the large language model. The interpretation of data sources is optionally automated and/or responds to queries/prompts, such as from the patent agent 20.

### Trade Secrets

Trade secrets are generally intended to be held secret within a company. However, there are times when trade secrets are intentionally released, such as to another corporation, to a government patent office, and/or to the public. For instance, the above described patent model 720 is optionally used to assess patentability of one or more elements of company held trade secrets with or without inclusion of additional elements. Particularly, patentability of one or more trade secrets is optionally assessed with the model assisted patent prosecution system 100, such as via the above described novelty assessment/patent model assessment idea. Similarly, the trade secrets are optionally included in the above described claim drafting and/or specification drafting capabilities of the model assisted patent prosecution system 100. Similarly, the trade secrets are optionally included in generation of the unofficial office action and/or the patent response. Generally, the model assisted patent prosecution system 100 optionally and preferably assists the decision maker, business executive, business official/businessman, patent agent 20, and/or the subject matter expert 30 in determining a likelihood of a patent being officially issued at a later date if one or more aspects of the trade secrets are released to the public in the form of a patent application. Notably, the assessment, such as with a probability, an unofficial patent office action, and/or a freedom to operate opinion, is available to the decision makers prior to releasing the trade secret elements in the form of the patent application. In one case, the probability model maps the trade secrets/assigns probabilities to patentability to combinations of trade secrets/mixtures of at least one trade secret with other claim language/elements.

### Large Language Model

The model assisted patent prosecution system 100 optionally and preferably leverages a large language model (LLM), which is a type of artificial intelligence model trained on data, such as text data, to understand, generate, and manipulate human language. The large language models optionally and preferably perform various language-related tasks like answering questions, summarizing text, translating languages, and even generating creative content, which are often based on transformer architectures.

The large language model optionally operates on data sources, such as to extract information, translate information, and/or load information into a database 50, such as a spreadsheet, documents, and/or to find/establish keywords. For example, the database 50 is then used by code, such as traditional code, an artificial intelligence model, and/or a probability model, such as to establish relationships between a patentable idea and prior art, such as through establishment of probability relationships between elements of the data sources.

### EXAMPLES

For clarity of presentation and without loss of generality, several examples of use of the model assisted patent prosecution system 100 are provided here.

### Example I

In a first example, a method/apparatus for assisting patent prosecution is described, comprising the steps of: (1) inputting, through an input system, a claim idea to a computer implemented patent prosecution model comprising an artificial neural network, the artificial neural network comprising at least an input layer, at least two hidden layers, and an output layer; (2) drafting a set of claims to the claim idea with the patent prosecution model; (3) generating for the set of claims, with the patent prosecution model, a first unofficial patent office action responsive to the set of claims in less than seven days, the first unofficial patent office action comprising at least one rejection of at least one claim of the set of claims based on at least one section of Article 35 of the United States Code; and (4) outputting, via an output system, the unofficial patent office action in a human readable form.

For instance, a method of using the model assisted patent prosecution system optionally includes any one or more of the steps of:
(1) including in the computer implemented patent prosecution model a probability inference model;
(2) drafting at least one claim in the set of claims with the probability inference model;
(3) including in the unofficial patent office action an unofficial patent office response to each claim of the set of claims;
(4) assessing, with a probability network, a potential prior art document linked to the probability network with a large language model to yield an assessed document; and
(5) including in the unofficial patent office action reference to the assessed document and/or including in the unofficial patent office action responses responsive in claim order to at least five sequential claims in the set of claims;
(6) determining that at least one claim in the first unofficial patent office action is unofficially allowed;
(7) filing to a patent office the at least one claim as part of a patent application;
(8) producing, with the patent prosecution model, a first response to the first unofficial patent office action, the first response citing at least one section of a Manual for Patent Examining Procedure published by a U.S. Patent and Trademark Office, the first response comprising at least one amended claim;
(9) performing steps of providing, drafting, generating, outputting, and producing claims in a short time, such as less than eight days;
(10) comparing relative numbers of cited prior art documents in article 35 U.S.C. 103 rejections in each of a first unofficial patent office action and a second unofficial patent office action;
(11) selecting the first amended claim as the preferred amended claim if the second unofficial patent office action comprises a notice of allowability to the first amended claim;
(12) including in the first unofficial patent office action all of:
   claim comments on each and every claim in the set of claims;
   first comments citing article 35 U.S.C. § 102; and
   second comments citing article 35 U.S.C. § 103, at least some of the first comments preceding the second comments in the unofficial patent office action;
(13) training, prior to the step of drafting, the patent prosecution model with at ten elements each from at least one thousand patent file wrappers containing documents and correspondence for corresponding patent applications in the U.S. Patent and Trademark Office;
(14) performing supervised learning of the patent prosecution model with at least one thousand independent sequences of: providing initial claims, prosecution analysis of the initial claims, and claim allowability outcomes of the initial claims, the initial claims, the prosecution analysis, and the claim allowability outcomes provided in the at least one thousand patent file wrappers; and/or
(15) assessing a CPC/IPC classification.

### Example II

In a second example, a method/apparatus is described for prosecuting a patent application, comprising the steps of:
(1) receiving an official office action from a patent office to the patent application;
(2) generating, with a patent model, a response to at least a part of the official office action; and
(3) filing the response to the patent office.

For instance, a method of using the model assisted patent prosecution system optionally includes any one or more of the steps of:
(1) producing the response with an artificial neural network model comprising an input layer, at least two hidden layers, and an output layer, the output layer yielding the response;
(2) training, prior to the step of generating, the artificial neural network model with portions of at least one thousand patent file wrappers first made public after Aug. 1, 2025 by a U.S. patent and trademark office, the portions comprising at least correspondence between a patent practitioner and the U.S. Patent and Trademark Office;
(3) passing to the artificial neural network data associated with the at least one thousand patent file wrappers;
(4) obtaining the meta data from at least one text description file identifying all of a title, an abstract, a specification, a class, a subclass, a claim, and a correspondence between a patent practitioner and a patent office in each of the at least one thousand patent file wrappers;
(5) training the neural network with output from a probability network, the probability network linked to potential prior art documents via a large language model;
(6) amending, via generated output from the neural network model, at least two claims in a claim set of the patent application;
(7) producing, with the neural network model, an argument for allowance of at least one claim in the claim set;
(8) cancelling, at least one claim in the claim set based on a cancellation recommendation from the neural network model;
(9) citing an argument output from the neural network model, the argument output quoting at least ten consecutive words from the Manual of Patent Examining Procedure;
(10) drafting a set of claims in the patent application with the patent model;
(11) training, prior to the step of generating, the artificial neural network model with portions of at least one thousand patent file wrappers first made public after Aug. 1, 2025 by a U.S. patent and trademark office, the portions comprising at least correspondence between a patent practitioner and the U.S. Patent and Trademark Office;
(12) passing to the artificial neural network meta data associated with the at least one thousand patent file wrappers;
(13) obtaining the meta data from at least one text description file identifying all of a title, an abstract, a specification, a class, a subclass, a claim, and a correspondence between a patent practitioner and a patent office in each of the at least one thousand patent file wrappers;
(14) training an artificial neural network of the patent model with output from a probability network;
(15) populating a database of the probability network with a large language model assessment of potential prior art documents;
(16) amending, via generated output from the neural network model, at least two claims in a claim set of the patent application;
(17) producing, with the neural network model, an argument for allowance of at least one claim in the claim set;
(18) cancelling, at least one claim in the claim set based on a cancellation recommendation from the neural network model;
(19) citing argument output from the neural network model, the argument output quoting at least ten consecutive words from the Manual of Patent Examining Procedure;
(20) training a probability network of the patent model with at least portions of at least ten patent application file wrappers originally obtained from a government patent office;
(21) determining, with the patent prosecution model, an expected classification class of the set of claims from a set of patent subject classes designated for a government patent office; and/or
(22) selecting the at least ten patent application file wrappers from a set of file wrappers associated with the expected classification class.

### Example III

In a third example, a method/apparatus is described for assessing a patent claim to an idea, comprising the steps of: (1) providing, to a probability model, the patent claim to the idea, the patent claim comprising a novelty hypothesis; (2) searching, with the probability model, potential prior art documents stored on a computer for keywords of the patent claim to establish prior art elements; (3) formulating probability relationships between the prior art elements in view of the novelty hypothesis; (4) calculating a patentability probability from through use of the probability relationships; and (5) outputting, in human readable form, from the probability model a patentability opinion of the patent claim, the patentability opinion comprising the patentability probability.

### Example IV

In a fourth example, a computer-implemented method for aiding patent prosecution is described, comprising the steps of: providing a set of claims, in a computer-readable medium, to a patent model, the set of claims comprising a first claim associated with a provided specification; searching the first claim with the patent model, the patent model comprising a neural network implemented in software on a computer system, the step of searching yielding a search result; generating, with the patent model and the search result, an unofficial office action to at least the first claim, the unofficial office action comprising an unofficial rejection under article 35 U.S.C. § 102; producing, with the patent model, a response to the unofficial office action, the step of producing adding an element to the first claim, the element included in the first claim in the response; outputting, via an output system, the response in a computer readable format; and optionally implementing the steps of searching, generating, and producing in commercial software.

### Example V

In a fifth example, a method is described comprising a method for prosecuting a claim of a set of claims in a patent application, comprising the steps of: inputting the claim as an input into a patent model, the patent model comprising an artificial neural network implemented on a computer system, the claim comprising at least a first element and a second element of a set of elements; assessing, with the patent model, a set of publications in a datastore for the presence of each of the first element and the second element; and reporting, as an output from the patent model, an unofficial office action comprising a claim novelty assessment for the claim, the claim novelty assessment comprising a first citation, of a first publication, of the set of publications in the datastore, citing: (1) a first snippet teaching the first element and (2) a second snippet teaching the second element.

Still yet another embodiment includes any combination and/or permutation of any of the elements described herein.

Herein, any number, such as 1, 2, 3, 4, 5, is optionally more than the number, less than the number, or within 1, 2, 5, 10, 20, or 50 percent of the number.

The main controller, a localized communication apparatus, and/or a system for communication of information optionally comprises one or more subsystems stored on a client. The client is a computing platform configured to act as a client device or other computing device, such as a computer, personal computer, a digital media device, and/or a personal digital assistant. The client comprises a processor that is optionally coupled to one or more internal or external input device, such as a mouse, a keyboard, a display device, a voice recognition system, a motion recognition system, or the like. The processor is also communicatively coupled to an output device, such as a display screen or data link to display or send data and/or processed information, respectively. The output system optionally and preferably provided any generated output in a machine readable and/or a human readable form. In one embodiment, the communication apparatus is the processor. In another embodiment, the communication apparatus is a set of instructions stored in memory that is carried out by the processor.

The client includes a computer-readable storage medium, such as memory. The memory includes, but is not limited to, an electronic, optical, magnetic, or another storage or transmission data storage medium capable of coupling to a processor, such as a processor in communication with a touch-sensitive input device linked to computer-readable instructions. Other examples of suitable media include, for example, a flash drive, a CD-ROM, read only memory (ROM), random access memory (RAM), an application-specific integrated circuit (ASIC), a DVD, magnetic disk, an optical disk, and/or a memory chip. The processor executes a set of computer-executable program code instructions stored in the memory. The instructions may comprise code from any computer-programming language, including, for example, C originally of Bell Laboratories, C++, C #, Visual Basic® (Microsoft, Redmond, WA), Matlab® (MathWorks, Natick, MA), Java® (Oracle Corporation, Redwood City, CA), and/or JavaScript® (Oracle Corporation, Redwood City, CA).

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for prosecuting a claim of a set of claims in a patent application, comprising the steps of:
inputting the claim as an input into a patent model, the patent model comprising an artificial neural network implemented on a computer system, the claim comprising at least a first element and a second element of a set of elements;
assessing, with the patent model, a set of publications in a datastore for the presence of each of the first element and the second element; and
reporting, as an output from the patent model, an unofficial office action comprising a claim novelty assessment for the claim, said claim novelty assessment comprising a first citation, of a first publication, of the set of publications in the datastore, citing: (1) a first snippet teaching the first element and (2) a second snippet teaching the second element.

2. The method of claim 1, further comprising the step of:
including non-patent literature in the set of publications, the first publication comprising a first non-patent publication.

3. The method of claim 2, further comprising the step of:
tagging the non-patent literature with cooperative patent classification codes.

4. The method of claim 3, said step of assessing further comprising the step of:
filtering the first citation, in the unofficial office action, to a require a cooperative patent classification designation matching a cooperative patent classification requirement.

5. The method of claim 4, further comprising the step of:
implementing the patent model in commercially available software.

6. The method of claim 5, further comprising the steps of:
replacing the claim with another claim from the set of claims; and
repeating both said step of assessing and said step of reporting.

7. The method of claim 6, said step of reporting further comprising the step of:
summarizing the claim novelty assessment in a table, the table, for each of at least ten claims, comprising:
a first mark if a corresponding table claim element is independent; and
marks for any corresponding presence of each of an unofficial 35 U.S.C. 101 rejection, an unofficial 35 U.S.C. 102 rejection, an unofficial 35 U.S.C. 103 rejection, and an unofficial 35 U.S.C. 112 rejection.

8. The method of claim 7, said step of summarizing further comprising the step of:
including in the table, for each of the at least ten claims, a claim depth referring to number of claims included past an independent claim.

9. The method of claim 8, said step of summarizing further comprising the step of:
including in the table, for each of the at least ten claims, an unofficial allowable claim mark.

10. The method of claim 9, further comprising the step of:
submitting, after said step of reporting, a member of the set of claims to the U.S. Patent and Trademark office as part of the patent application.

11. The method of claim 1, further comprising the step of:
submitting, after said step of reporting, a member of the set of claims to the U.S. Patent and Trademark office as part of the patent application.

12. The method of claim 11, said step of reporting further comprising the step of:
summarizing the claim novelty assessment in a table, the table, for each of at least claims 1 to 10, comprising:
marks for any corresponding presence of each of an unofficial 35 U.S.C. 101 rejection, an unofficial 35 U.S.C. 102 rejection, an unofficial 35 U.S.C. 103 rejection, and an unofficial 35 U.S.C. 112 rejection.

13. The method of claim 1, said step of assessing further comprising the step of:
filtering the first citation, in the unofficial office action, to a require a cooperative patent classification designation matching a cooperative patent classification requirement input by a user.

14. The method of claim 13, said step or filtering further comprising the steps of:
limiting the first citation to a member of the set of publications where the cooperative patent classification comprises a section, class, sub-class, and group that match the cooperative patent classification designation of the claim; and
allowing the first citation to not match the cooperative patent classification designation at a sub-group level.

15. The method of claim 14, further comprising the step of:
inputting, to the patent model, the claim as a complete claim sentence.

16. The method of claim 1, further comprising the step of:
reporting a probability of the claim being allowed, said step of reporting determining the probability based on a number of unofficial 35 U.S.C. 103 rejections to the claim determined in said step of assessing.

17. An apparatus configured to prosecute a claim of a set of claims in a patent application, comprising:
a patent model comprising an artificial neural network implemented on a computer system, the patent model configured to receive the claim as an input, the claim comprising at least a first element and a second element of a set of elements;
the patent model configured to assess, a set of publications in a datastore for the presence of each of the first element and the second element; and
the patent model configured to report an unofficial office action comprising a claim novelty assessment for the claim, said claim novelty assessment comprising a first citation, of a first publication, of the set of publications in the datastore, citing: (1) a first snippet teaching the first element and (2) a second snippet teaching the second element.
